(19) United States
(12) Patent Application Publication
(10) Pub. No.: US 2024/0340754 A1
(43) Pub. Date: Oct. 10, 2024

(54) METHOD AND APPARATUS FOR SECURITY HANDLING IN SUBSEQUENT CONDITIONAL PSCELL CHANGE IN NEXT GENERATION WIRELESS SYSTEMS

(71) Applicant: Samsung Electronics Co., Ltd., Suwon-si (KR)

(72) Inventor: June HWANG, Suwon-si (KR)

(21) Appl. No.: 18/628,024

(22) Filed: Apr. 5, 2024

(30) Foreign Application Priority Data
Apr. 6, 2023 (KR) 10-2023-0045402

(51) Int. Cl. H04W 36/36; H04W 36/00; H04W 76/20

(52) U.S. Cl. CPC H04W 36/362; H04W 36/0038; H04W 76/20

(57) ABSTRACT

The disclosure relates to a 5G or 6G communication system for supporting a higher data transmission rate. A method performed by a terminal in a wireless communication system is provided. The method includes receiving, from a base station, information on a subsequent conditional primary secondary cell group (SCG) cell (PSCell) change configuration and information on a list of sk-counter values, identifying that a condition associated with a subsequent PSCell change execution for a target cell is fulfilled based on the subsequent PSCell change configuration, determining a firstly listed entry in the list of sk-counter values as an sk-counter value for a security key update, and applying configuration information for the target cell.

### CROSS-REFERENCE TO RELATED APPLICATION(S)

This application is based on and claims priority under 35 U.S.C. § 119(a) of a Korean patent application number 10-2023-0045402, filed on Apr. 6, 2023, in the Korean Intellectual Property Office, the disclosure of which is incorporated by reference herein in its entirety.

### BACKGROUND

### 1. Field

The disclosure relates to a mobile communication system. More particularly, the disclosure relates to subsequent conditional primary secondary cell group (SCG) cell (PSCell) change.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As various services can be provided in accordance with the above-described technologies and the development of mobile communication systems, there is a need for a method to effectively provide these services.

The above information is presented as background information only to assist with an understanding of the disclosure. No determination has been made, and no assertion is made, as to whether any of the above might be applicable as prior art with regard to the disclosure.

### SUMMARY

The disclosure is to address the issue of allocating a security key in case where a change is made between other secondary nodes when a terminal performs a subsequent conditional PSCell change operation in a communication system.

Aspects of the disclosure are to address at least the above-mentioned problems and/or disadvantages and to provide at least the advantages described below. Accordingly, an aspect of the disclosure is to provide a method and apparatus for security handling in subsequent conditional PSCell change in next generation wireless systems.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, information on a subsequent conditional primary secondary cell group (SCG) cell (PSCell) change configuration and information on a list of sk-counter values, identifying that a condition associated with a subsequent PSCell change execution for a target cell is fulfilled based on the subsequent PSCell change configuration, determining a firstly listed entry in the list of sk-counter values as an sk-counter value for a security key update, and applying configuration information for the target cell.

In accordance with another aspect of the disclosure, a method performed by a base station in a wireless communication system is provided. The method includes transmitting, to each of at least one secondary node (SN), an SN addition request message indicating that a subsequent conditional PSCell change is requested, in response to the SN addition request message, receiving, from each of the at least one SN, an SN addition request acknowledgement message including configuration information for the subsequent conditional PSCell change, and based on the configuration information, transmitting, to a terminal, information on a subsequent conditional PSCell change configuration and information on a list of sk-counter values, wherein a firstly listed entry in the list of sk-counter values is determined as an sk-counter value for a security key update.

In accordance with another aspect of the disclosure, a terminal in a wireless communication system is provided. The terminal includes a transceiver, memory storing one or more computer programs, and one or more processors communicatively coupled to the transceiver and the memory, wherein the one or more computer programs include computer-executable instructions that, when executed by the one or more processors, cause the terminal to receive, from a base station via the transceiver, information on a subsequent conditional PSCell change configuration and information on a list of sk-counter values, identify that a condition associated with a subsequent conditional PSCell change execution for a target cell is fulfilled based on the subsequent conditional PSCell change configuration, determine a firstly listed entry in the list of sk-counter values as an sk-counter value for a security key update, and apply configuration information for the target cell.

In accordance with another aspect of the disclosure, a base station in a wireless communication system is provided. The base station includes a transceiver, memory storing one or more computer programs, and one or more processors communicatively coupled to the transceiver and the memory, wherein the one or more computer programs include computer-executable instructions that, when executed by the one or more processors, cause the base station to transmit, to each of at least one SN via the transceiver, an SN addition request message indicating that a subsequent conditional PSCell change is requested, in response to the SN addition request message, receive, from each of the at least one SN via the transceiver, an SN addition request acknowledgement message including configuration information for the subsequent conditional PSCell change, and based on the configuration information, transmit, to a terminal via the transceiver, information on a subsequent conditional PSCell change configuration and information on a list of sk-counter values, wherein a firstly listed entry in the list of sk-counter values is determined as an sk-counter value for a security key update.

In accordance with another aspect of the disclosure, one or more non-transitory computer-readable storage media storing computer-executable instructions that, when executed by one or more processors of a terminal, cause the terminal to perform operations are provided. The operations include receiving, from a base station, information on a subsequent conditional primary secondary cell group (SCG) cell (PSCell) change configuration and information on a list of sk-counter values, identifying that a condition associated with a subsequent conditional PSCell change execution for a target cell is fulfilled based on the subsequent conditional PSCell change configuration, determining a firstly listed entry in the list of sk-counter values as an sk-counter value for a security key update, and applying configuration information for the target cell.

According to an embodiment of the disclosure, a network performs subsequent conditional PSCell change operations without problems by allocating multiple security keys to a terminal in advance, or allocates one key and providing counter value information corresponding to the one key to the terminal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long term evolution (LTE) system according to an embodiment of the disclosure;

FIG. 2 illustrates a wireless protocol structure in an LTE system according to an embodiment of the disclosure;

FIG. 3 illustrates a structure of a next-generation mobile communication system according to an embodiment of the disclosure;

FIG. 4 illustrates a wireless protocol structure in a next-generation mobile communication system according to an embodiment of the disclosure;

FIG. 5 illustrates a structure of a user equipment (UE) according to an embodiment of the disclosure;

FIG. 6 illustrates a structure of a new radio (NR) base station according to an embodiment of the disclosure;

FIG. 7A illustrates a master node (MN)-initiated subsequent conditional PSCell change (CPC) procedure in OPT1 according to an embodiment of the disclosure;

FIG. 7B illustrates an MN-initiated subsequent CPC procedure in OPT1 according to an embodiment of the disclosure;

FIG. 7C illustrates an MN-initiated subsequent CPC procedure in OPT1 according to an embodiment of the disclosure;

FIG. 7D illustrates an MN-initiated subsequent CPC procedure in OPT1 according to an embodiment of the disclosure;

FIG. 8A illustrates an SN-initiated subsequent CPC procedure in OPT1 according to an embodiment of the disclosure;

FIG. 8B illustrates an SN-initiated subsequent CPC procedure in OPT1 according to an embodiment of the disclosure;

FIG. 8C illustrates an SN-initiated subsequent CPC procedure in OPT1 according to an embodiment of the disclosure;

FIG. 8D illustrates an SN-initiated subsequent CPC procedure in OPT1 according to an embodiment of the disclosure;

FIG. 9A illustrates an MN-initiated subsequent CPC procedure in OPT2 according to an embodiment of the disclosure;

FIG. 9B illustrates an MN-initiated subsequent CPC procedure in OPT2 according to an embodiment of the disclosure;

FIG. 9C illustrates an MN-initiated subsequent CPC procedure in OPT2 according to an embodiment of the disclosure;

FIG. 9D illustrates an MN-initiated subsequent CPC procedure in OPT2 according to an embodiment of the disclosure;

FIG. 10A illustrates an SN-initiated subsequent CPC procedure in OPT2 according to an embodiment of the disclosure;

FIG. 10B illustrates an SN-initiated subsequent CPC procedure in OPT2 according to an embodiment of the disclosure;

FIG. 10C illustrates an SN-initiated subsequent CPC procedure in OPT2 according to an embodiment of the disclosure;

FIG. 10D illustrates an SN-initiated subsequent CPC procedure in OPT2 according to an embodiment of the disclosure; and

FIG. 11 illustrates a process for generating a K_{SN} in a UE and MN in a conditional subsequent SN change in a dual connectivity situation according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms identifying access nodes, terms indicating network entities, terms indicating messages, terms indicating interfaces between network entities, terms indicating various types of identification information, or the like, are merely selected for convenience of explanation. Therefore, the disclosure is not limited to these terms and other terms having technically equivalent meanings may also be used.

Hereinafter, a base station may be an entity allocating resource to a terminal and may be at least one of gNode B, eNodeB, Node B, base station (BS), radio access unit, base station controller, and node over network. The terminal may include user equipment (UE), mobile station (MS), cellular phone, smartphone, computer, or multimedia system capable of performing communication functions. In the disclosure, a downlink (DL) may refer to a wireless transmission path of signal transmitted from the base station to the terminal, and an uplink (UL) refers to a wireless transmission path of signal transmitted from the terminal to the base station. In addition, although LTE or LTE-advanced (LTE-A) system is described as an example, embodiments of the disclosure may also apply to other communication systems with a similar technical background or channel form. For example, the 5th generation mobile communication technology (5G, new radio, NR) developed after LTE-A may be included in a system to which embodiments of the disclosure can be applied. Hereinafter, 5G may be a concept that includes existing LTE, LTE-A, and other similar services. Furthermore, the disclosure will also be applied to other communication systems through some modifications to an extent that does not significantly deviate from the scope of the disclosure when judged by those of ordinary skill in the art. Here, it will be understood that combinations of blocks in flowcharts or process flow diagrams may be performed by computer program instructions.

Because these computer program instructions may be loaded into a processor of a general purpose computer, a special purpose computer, or another programmable data processing apparatus, the instructions, which are performed by a processor of a computer or another programmable data processing apparatus, generate means for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction means for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function. Here, the term “unit” used in the disclosure means a software component or hardware component, such as field programmable gate array (FPGA) or application specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components, such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be further divided into additional components and “units”. Furthermore, the components and “units” may be embodied to reproduce one or more CPUs in a device or security multimedia card. In addition, in an embodiment of the disclosure, ‘units’ may include one or more processors.

For convenience of explanation below, the disclosure will be described using terms and names defined in the 5GS and NR standards, which are the standards defined by the 3rd generation partnership project (3GPP) organization among the existing communication standards. However, the disclosure is not limited by these terms and names, and may be applied in the same way to wireless communication networks that conform other standards. For example, the disclosure may be applied to the 3GPP 5GS/NR (5th generation mobile communication standards).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

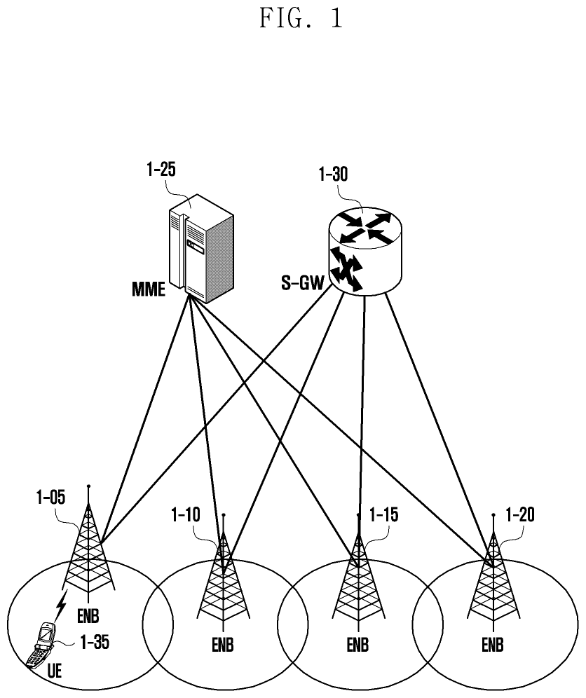

FIG. 1 illustrates a structure of an LTE system according to an embodiment of the disclosure.

Referring to FIG. 1, a radio access network of the LTE system may include next-generation base stations (evolved Node Bs, hereinafter ENBs, Node Bs, or base stations) 1-05, 1-10, 1-15, and 1-20, a mobility management entity (MME) 1-25, and a serving gateway (S-GW) 1-30. A user equipment (hereinafter, UE or terminal) 1-35 may access an external network through the ENBs 1-05 to 1-20 and the S-GW 1-30.

Referring to FIG. 1, the ENBs 1-05 to 1-20 may correspond to existing node Bs of an universal mobile telecommunications system (UMTS) system. The ENBs may be connected to the UE 1-35 via a radio channel and perform a more complicated role than that of the existing node B. In an LTE system, user traffic including a real-time service, such as voice over IP (VoIP) via an Internet protocol may be served through a shared channel. Accordingly, a device for collecting and scheduling status information, such as buffer statuses of UEs, available transmission power status, and channel statuses may be required, and the ENBs 1-05 to 1-20 may serve as this device. One ENB may typically control a plurality of cells. For example, in order to implement a transmission rate of 100 Mbps, the LTE system may use orthogonal frequency division multiplexing (OFDM) as a wireless access technology in a bandwidth of 20 MHz. Further, an adaptive modulation and coding (AMC) scheme of determining a modulation scheme and a channel-coding rate may be applied depending on the channel status of the UE. The S-GW 1-30 is a device for providing a data bearer, and generates or removes the data bearer under a control of the MME 1-25. The MME is a device for managing the mobility of the UE and performing various control functions, and may be connected to the plurality of base stations.

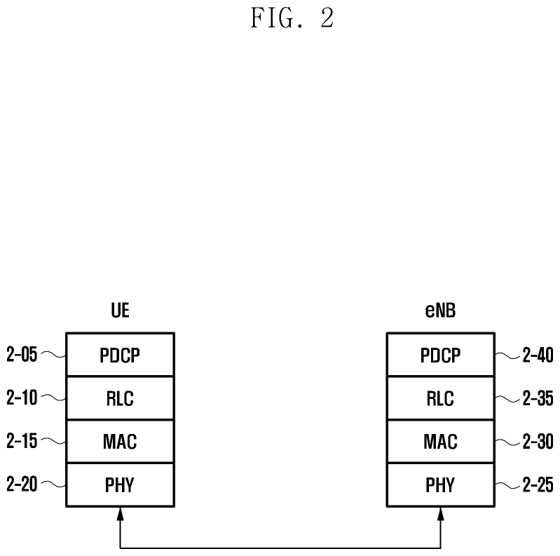

FIG. 2 illustrates a wireless protocol structure in an LTE system according to an embodiment of the disclosure.

Referring to FIG. 2, a UE and an ENB may include packet data convergence protocols (PDCPs) 2-05 and 2-40, radio link controls (RLCs) 2-10 and 2-35, medium access controls (MACs) 2-15 and 2-30, respectively, in the wireless protocol of the LTE system. The PDCPs may compress/reconstruct an IP header. The main functions of the PDCPs include the following:
Header compression and decompression function (header compression and decompression: robust header compression (ROHC) only)
User data transmission function (transfer of user data)
Sequential delivery function (in-sequence delivery of upper layer packet data units (PDUs) at PDCP re-establishment procedure for RLC acknowledged mode (AM))
Sequence re-arrangement function (for split bearers in DC (only support for RLC AM): PDCP PDU routing for transmission and PDCP PDU reordering for reception)
Duplicate detection function (duplicate detection of lower layer service data units (SDUs) at PDCP re-establishment procedure for RLC AM)
Retransmission function (retransmission of PDCP SDUs at handover and, for split bearers in DC, of PDCP PDUs at PDCP data-recovery procedure, for RLC AM)
Ciphering and deciphering function (ciphering and deciphering)
Timer-based SDU discard function (Timer-based SDU discard in uplink.)

Radio link controls (RLCs) 2-10 and 2-35 may reconstruct a PDCP packet data unit (PDU) to be the appropriate size and perform an automatic repeat request (ARQ) operation, or the like. The main functions of the RLC include the following.
Data transmission function (transfer of upper layer PDUs)
ARQ function (error Correction through ARQ (only for AM data transfer))
Concatenation, segmentation, and reassembly function (concatenation, segmentation and reassembly of RLC SDUs (only for unacknowledged mode (UM) and AM data transfer))
Re-segmentation function (re-segmentation of RLC data PDUs (only for AM data transfer))
Reordering function (reordering of RLC data PDUs (only for UM and AM data transfer)
Duplication detection function (duplicate detection (only for UM and AM data transfer))
Error detection function (protocol error detection (only for AM data transfer))
RLC SDU discard function (RLC SDU discard (only for UM and AM data transfer))
RLC re-establishment function (RLC re-establishment)

The MACs 2-15 and 2-30 may be connected with various RLC layer devices included in one UE, and multiplex RLC PDUs to the MAC PDU and demultiplex the RLC PDUs from the MAC PDU. The main functions of the MAC include the following.
Mapping function (mapping between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information report function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The PHYs 2-20 and 2-25 may perform an operation of channel-coding and modulating upper-layer data to generate an OFDM symbol and transmitting the OFDM symbol via a radio channel or demodulating and channel-decoding the OFDM symbol received via a radio channel and transmitting the demodulated and channel-decoded OFDM symbol to an upper layer.

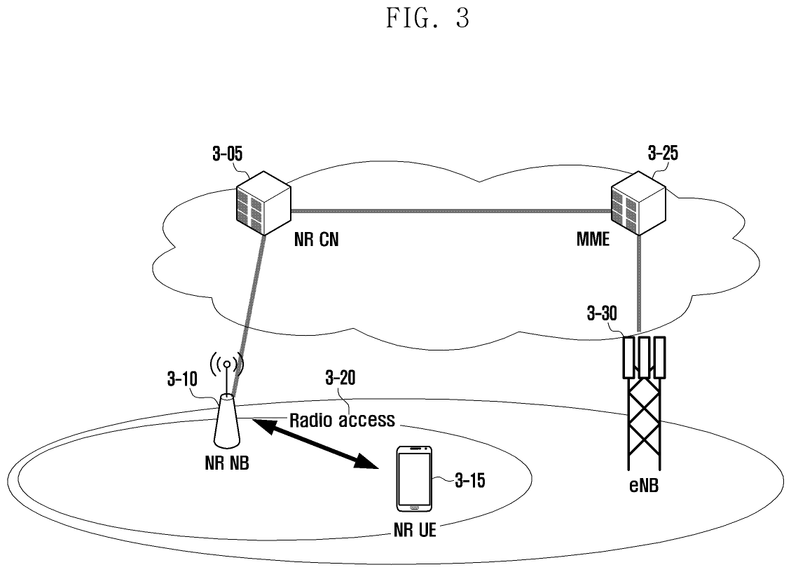

FIG. 3 illustrates a structure of a next-generation mobile communication system according to an embodiment of the disclosure.

Referring to FIG. 3, a radio access network 3-20 of the next-generation mobile communication system (e.g., NR or 5G) may include a next-generation base station (new radio node B, NR gNB or NR BS) 3-10 and a next generation radio core network (new radio core network, NR CN) 3-05. A next generation radio user equipment (new radio user equipment, NR UE, or terminal) 3-15 may access an external network through the NR gNB 3-10 and the NR CN 3-05.

In FIG. 3, the NR gNB 3-10 may correspond to an evolved node B (eNB) in an existing LTE system. The NR gNB may be connected to the NR UE 3-15 via a radio channel and may provide better service than an existing node B. All user traffic may be served via a shared channel in the next-generation mobile communication system. Accordingly, a device for collecting and scheduling status information of buffer statuses, available transmission power statuses, and channel statuses of UEs may be required, and the NR gNB 3-10 may serve the scheduling. One NR gNB may control a plurality of cells. In the next-generation mobile communication system, a bandwidth wider than the maximum bandwidth of the related art may be applied in order to implement super-high-speed data transmission compared to a LTE of the related art. In addition, orthogonal frequency division multiplexing (OFDM) via radio-access technology may further apply beamforming technology. Further, an adaptive modulation and coding (hereinafter referred to as AMC) scheme of determining a modulation scheme and a channel coding rate may be applied depending on the channel status of the UE. The NR CN 3-05 may perform a function of supporting mobility, configuring a bearer, configuring quality of service (QoS), or the like. The NR CN is a device for managing the mobility of the UE and performing various control functions, and may be connected to a plurality of BSs. Further, the next-generation mobile communication system may be linked to the LTE system, and the NR CN may be connected to an MME 3-25 via a network interface. The MME may be connected to an eNB 3-30, which is an LTE BS.

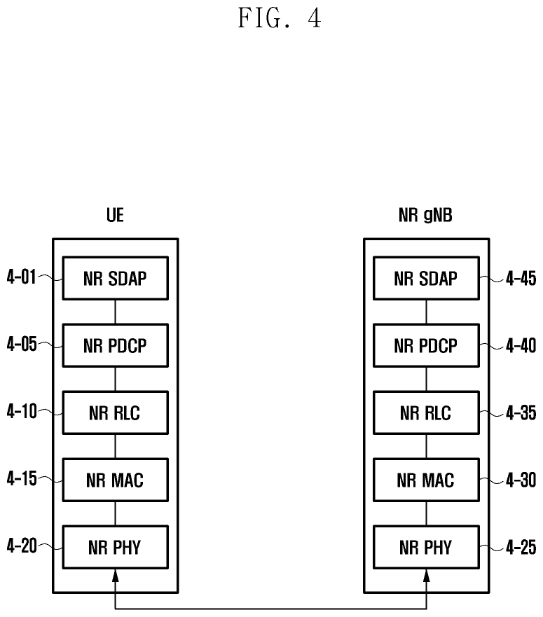

FIG. 4 illustrates a wireless protocol structure in a next-generation mobile communication system according to an embodiment of the disclosure.

Referring to FIG. 4, a UE and an NR BS include NR service data application protocols (service data adaptation protocols, SDAPs) 4-01 and 4-45, NR PDCPs 4-05 and 4-40, NR RLCs 4-10 and 4-35, NR MACs 4-15 and 4-30, and NR PHYs 4-20 and 4-25 in the wireless protocol of the next-generation mobile communication system.

The main functions of the NR SDAPs 4-01 and 4-45 may include some of the following functions.
User data transmission function (transfer of user plane data)
Function of mapping QoS flow and a data bearer for UL and DL (mapping between a QoS flow and a data radio bearer (DRB) for both DL and UL)
Function of marking a QoS flow ID for UL and DL (marking QoS flow ID in both DL and UL packets)
Function of mapping reflective QoS flow to a data bearer for UL SDAP PDUs (reflective QoS flow to DRB mapping for the UL SDAP PDUs).

With respect to the SDAP layer device, the UE may receive a configuration as to whether to use a header of the SDAP layer device or a function of the SDAP layer device for each PDCP layer device, each bearer, or each logical channel through a radio resource control (RRC) message. In case of the SDAP header is configured, a 1-bit indication of non-access stratum (NAS) reflective quality of service (QoS) of the SDAP header and a 1 bit-indication of access stratum (AS) reflective QoS may indicate that the UE updates or reconfigures information on mapping of QoS flow and a data bearer in UL and DL. The SDAP header may include QoS flow ID information indicating the QoS. The QoS information may be used as data-processing-priority or scheduling information to support a seamless service.

The main functions of the NR PDCPs 4-05 and 4-40 may include some of the following functions:
Header compression and decompression function (Header compression and decompression: ROHC only)
User data transmission function (transfer of user data)
Sequential delivery function (in-sequence delivery of upper layer PDUs)
Non-sequential delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUS)
Ciphering and deciphering function (ciphering and deciphering)
Timer-based SDU discard function (timer-based SDU discard in uplink.)

In the descriptions above, the reordering function of the NR PDCP device is a function of sequentially reordering PDCP PDUs received from a lower layer, based on a PDCP sequence number (SN). The reordering function of the NR PDCP device may include a function of sequentially transmitting the reordered data to an upper layer, a function of directly transmitting the reordered data without considering the order, a function of recording PDCP PDUs lost due to the reordering, a function of reporting statuses of the lost PDCP PDUs to a transmitting end, and a function of making a request for retransmitting the lost PDCP PDUs.

The main functions of the NR RLCs 4-10 and 4-35 may include some of the following functions.
Data transmission function (transfer of upper layer PDUs)
Sequential delivery function (in-sequence delivery of upper layer PDUs)
Non-sequential delivery function (out-of-sequence delivery of upper layer PDUs)
ARQ function (error Correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

In the descriptions above, the sequential delivery function (in-sequence delivery) of the NR RLC device is a function of sequentially transmitting RLC SDUs received from a lower layer to an upper layer. In case where one original RLC SDU is segmented into a plurality of RLC SDUs and received, the sequential delivery function (In-sequence delivery) of the NR RLC device may include a function of reassembling and transmitting the RLC SDUs.

The sequential delivery function (in-sequence delivery) of the NR RLC device may include a function of reordering the received RLC PDUs, based on an RLC sequence number (SN) or PDCP sequence number (SN), a function of recording RLC PDUs lost due to the reordering, a function of reporting statuses of the lost RLC PDUs to a transmitting end, and a function of making a request for retransmitting the lost RLC PDUs.

The sequential delivery function (in-sequence delivery) of the NR RLC device may include, in case where there is a lost RLC SDU, a function of sequentially transferring, to the upper layer, only RLC SDUs preceding the lost RLC SDU.

The sequential delivery function (in-sequence delivery) of the NR RLC device may include, if a predetermined timer expires when there is a lost RLC SDU, a function of sequentially transmitting, to the upper layer, all RLC SDUs received before the timer starts.

The sequential delivery function (in-sequence delivery) of the NR RLC device may include, if a predetermined timer expires when there is a lost RLC SDU, a function of sequentially transmitting, to the upper layer, all RLC SDUs received up to that point in time.
The NR RLC device may process the RLC PDUs sequentially in the order of reception thereof, regardless of the order of the sequence number (out-of sequence delivery) and may transmit the RLC PDUs to the NR PDCP device.

In the case of receiving segments, the NR RLC device may receive segments that are stored in the buffer or are to be received in the future, reconstitute the segments to be one RLC PDU, and then transmit the same to the NR PDCP device.

The NR RLC layer may not include a concatenation function, and the function may be performed by the NR MAC layer, or may be replaced with a multiplexing function of the NR MAC layer.

In the descriptions above, the non-sequential delivery function (out-of-sequence delivery) of the NR RLC device may refer to a function of transmitting RLC SDUs received from a lower layer directly to an upper layer regardless of the sequence of the received RLC SDUs. The non-sequential delivery function (out-of-sequence delivery) of the NR RLC device may include, in case where one original RLC SDU is segmented into a plurality of RLC SDUs and then received, a function of reassembling and transmitting the RLC PDUs. The non-sequential delivery function (out-of-sequence delivery) of the NR RLC device may include a function of storing RLC SNs or PDCP SNs of the received RLC PDUs, reordering the RLC PDUs, and recording lost RLC PDUs.

The NR MACs 4-15 and 4-30 may be connected to a plurality of NR RLC layer devices constituted in one UE and the main functions of the NR MAC may include some of the following functions.
Mapping function (mapping between logical channels and transport channels)
Multiplexing and demultiplexing function (multiplexing/demultiplexing of MAC SDUs)
Scheduling information report function (scheduling information reporting)
HARQ function (error correction through HARQ)
Priority handling between logical channels (priority handling between logical channels of one UE)
Priority handling between UEs (priority handling between UEs by means of dynamic scheduling)
MBMS service identification function (MBMS service identification)
Transport format selection function (transport format selection)
Padding function (padding)

The NR PHY layers 4-20 and 4-25 may perform an operation for channel-coding and modulating upper layer data to generate an OFDM symbol and transmitting the OFDM symbol via a radio channel or demodulating and channel-decoding the OFDM symbol received via the radio channel and transmitting the demodulated and channel-decoded OFDM symbol to the upper layer.

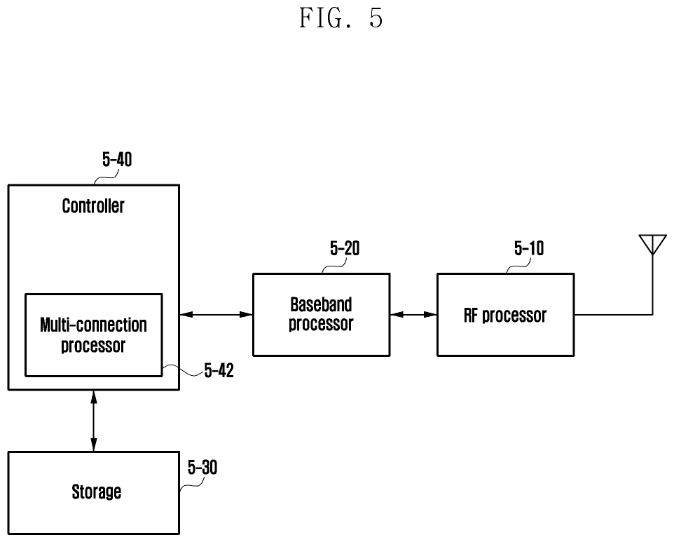

FIG. 5 illustrates a structure of a UE according to an embodiment of the disclosure.

Referring to FIG. 5, a UE (or terminal) includes a radio frequency (RF) processor 5-10, a baseband processor 5-20, a storage 5-30, and a controller 5-40.

The RF processor 5-10 performs a function of transmitting and receiving a signal via a radio channel, such as converting or amplifying a band of the signal. The RF processor 5-10 up-converts a baseband signal provided from the baseband processor 5-20 into an RF band signal, transmits the RF band signal through an antenna, and then down-converts the RF band signal received through the antenna into a baseband signal. For example, the RF processor 5-10 may include a transmission filter, a reception filter, an amplifier, a mixer, an oscillator, a digital to analog converter (DAC), an analog to digital converter (ADC), or the like. Although the drawing illustrates only one antenna, the UE may include a plurality of antennas. In addition, the RF processor 5-10 may include a plurality of RF chains. The RF processor 5-10 may perform beamforming. For the beamforming, the RF processor 5-10 may control a phase and size of each of the signals transmitted/received through a plurality of antennas or antenna elements. In addition, the RF processor 5-10 may perform MIMO and receive a plurality of layers when performing the MIMO operation.

The baseband processor 5-20 performs a function for a conversion between a baseband signal and a bitstream according to a physical layer standard of the system. For example, in data transmission, the baseband processor 5-20 generates complex symbols by encoding and modulating a transmission bitstream. Further, in data reception, the baseband processor 5-20 reconstructs a reception bitstream by demodulating and decoding a baseband signal provided from the RF processor 5-10. For example, according to an orthogonal frequency division multiplexing (OFDM) scheme, when data is transmitted, the baseband processor 5-20 generates complex symbols by encoding and modulating a transmission bitstream, mapping the complex symbols to subcarriers, and then constructs OFDM symbols through an inverse fast Fourier transform (IFFT) operation and a cyclic prefix (CP) insertion. Further, in data reception, the baseband processor 5-20 segments the baseband signal provided from the RF processor 5-10 in units of OFDM symbols, reconstructs the signals mapped to the subcarriers through a fast Fourier transform (FFT) operation, and then reconstructs a reception bitstream through demodulation and decoding.

The baseband processor 5-20 and the RF processor 5-10 transmit and receive the signal as described above. Accordingly, each of the baseband processor 5-20 and the RF processor 5-10 may be referred to as a transmitter, a receiver, a transceiver, or a communicator. Further, at least one of the baseband processor 5-20 and the RF processor 5-10 may include a plurality of communication modules to support a plurality of different radio access technologies. In addition, at least one of the baseband processor 5-20 and the RF processor 5-10 may include different communication modules to process signals in different frequency bands. For example, the different radio access technologies may include a wireless local area network (LAN) (e.g., IEEE 802.11), a cellular network (e.g., LTE), or the like. Further, the different frequency bands may include a super high frequency (SHF) (e.g., 2. NRHz, NRhz) band and a millimeter (mm) wave (e.g., 60 GHZ) band.

The storage 5-30 stores data, such as a basic program, an application, configuration information, or the like, for the operation of the UE. More particularly, the storage 5-30 may store information related to a second access node performing wireless communication by using a second wireless access technology. The storage 5-30 provides stored data according to a request from the controller 5-40.

The controller 5-40 may include multi-connection processor 5-42 and controls the overall operation of the UE. For example, the controller 5-40 transmits and receives signals through the baseband processor 5-20 and the RF processor 5-10. Further, the controller 5-40 record data in the storage 5-30 and reads the data. To this end, the controller 5-40 may include at least one processor. For example, the controller 5-40 may include a communication processor (CP) that performs control for communication, and an application processor (AP) that controls an upper layer, such as an application.

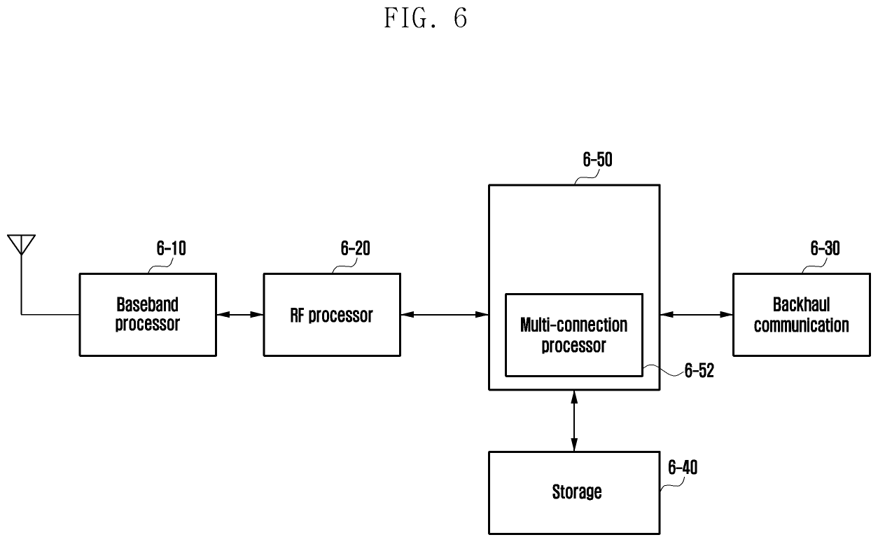

FIG. 6 illustrates a structure of an NR base station according to an embodiment of the disclosure.

Referring to FIG. 6, the base station (BS) is constituted to include an RF processor 6-10, a baseband processor 6-20, a backhaul communicator 6-30, a storage 6-40, and a controller 6-50.

The RF processor 6-10 performs a function of transmitting and receiving a signal via a radio channel, such as converting or amplifying a band of the signal. The RF processor 6-10 up-converts a baseband signal provided from the baseband processor 6-20 into an RF band signal and then transmits the converted signal through an antenna, and down-converts an RF band signal received through the antenna into a baseband signal. For example, the RF processor 6-10 may include a transmission filter, a reception filter, an amplifier, a mixer, an oscillator, a DAC, an ADC, or the like. Although the above drawing illustrates only one antenna, the first access node may include a plurality of antennas. In addition, the RF processor 6-10 may include a plurality of RF chains. Further, the RF processor 6-10 may perform beamforming. For the beamforming, the RF processor 6-10 may control the phase and size of each of the signals transmitted and received through a plurality of antennas or antenna elements. The RF processor may perform a DL MIMO operation by transmitting one or more layers.

The baseband processor 6-20 performs a function of performing conversion between a baseband signal and a bitstream according to a physical layer standard of the first radio access technology. For example, in data transmission, the baseband processor 6-20 generates complex symbols by encoding and modulating a transmission bitstream. Further, in data reception, the baseband processor 6-20 reconstructs a reception bitstream by demodulating and decoding a baseband signal provided from the RF processor 6-10. For example, according to an OFDM scheme, in data transmission, the baseband processor 6-20 generates complex symbols by encoding and modulating the transmission bitstream, maps the complex symbols to subcarriers, and then constructs OFDM symbols through an IFFT operation and CP insertion. In addition, in data reception, the baseband processor 6-20 segments a baseband signal provided from the RF processor 6-10 in units of OFDM symbols, recovers signals mapped with sub-carriers through an FFT operation, and then reconstructs a reception bitstream through demodulation and decoding. The baseband processor 6-20 and RF processor 6-10 transmit and receive the signal as described above. Accordingly, each of the baseband processor 6-20 and the RF processor 6-10 may be referred to as a transmitter, a receiver, a transceiver, a communicator, or a wireless communicator.

The backhaul communicator 6-30 provides an interface for communicating with other nodes in the network. The backhaul communicator 6-30 converts a bitstream to be transmitted from the main BS to the other node, e.g., a secondary BS, a core network, or the like, into a physical signal and converts a physical signal received from the other node into a bitstream.

The storage 6-40 stores data, such as a basic program, an application, configuration information, or the like, for the operation of the main BS. More particularly, the storage 6-40 may store information on bearers allocated to the accessed UE, a measurement result reported from the accessed UE, or the like. Further, the storage 6-40 may store information that is a reference for determining whether to provide or stop multiple connections to the UE. The storage 6-40 provides stored data according to a request from the controller 6-50.

The controller 6-50 may include multi-connection processor 6-52 and controls the overall operation of the BS. For example, the controller 6-50 transmits and receives a signal through the baseband processor 6-20 and the RF processor 6-10 or through the backhaul communicator 6-30. Further, the controller 6-50 records data in the storage 6-40 and reads the data. To this end, the controller 6-50 may include at least one processor.

Meanwhile, hereinafter, a method for handling a security key for subsequent conditional PSCell change operations is provided. More particularly, in case where a secondary node is changed when the UE performs a subsequent conditional PSCell change operation, the subsequent conditional PSCell operation is supported by providing a method for allocating a security key. Hereinafter, a key may refer to S-KgNB, and a counter may refer to sk-counter. In addition, hereinafter, the subsequent conditional PSCell change operation may be used interchangeably with subsequent conditional PSCell change (CPC).

In addition, hereinafter, terms, such as CPC and subsCPC may be used interchangeably with subsequent CPC, and a target candidate SN may be used interchangeably with a candidate SN.

The disclosure proposes OPT1 and OPT2, and hereinafter, OPT1 will be described first.

OPT1: This refers to a case where multiple pairs of keys and associated counters are determined in advance and given to the UE with a CPC configuration. This is a case where the same key value is used in case of subsequent intra-SN CPCs.

In addition, CPC exists in both master node (MN)-initiated and secondary node (SN)-initiated cases. First, in the case of MN-initiated, the following procedures may be considered.

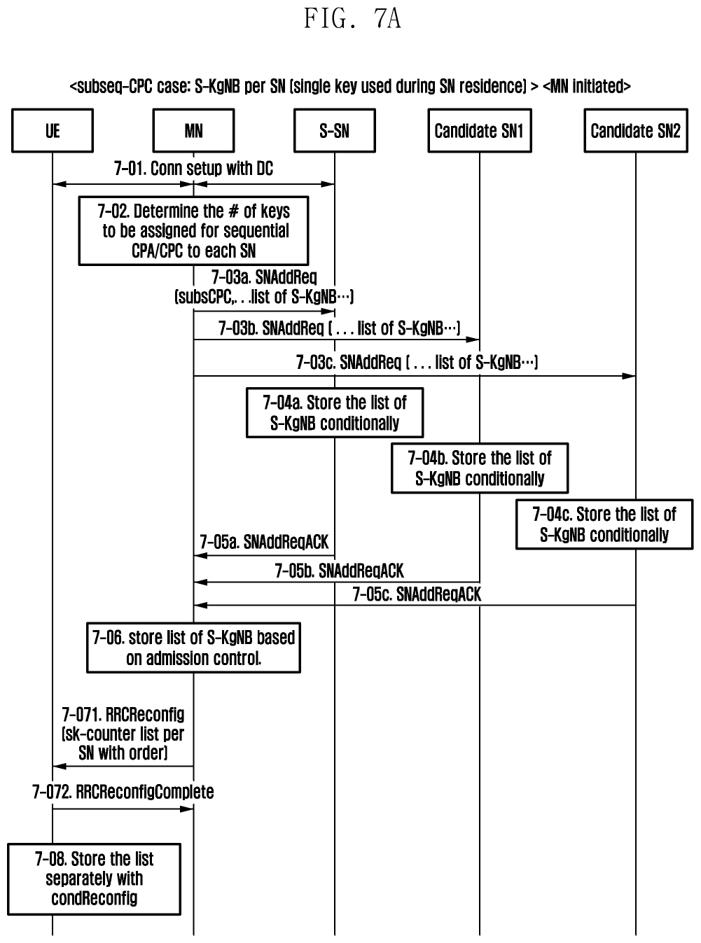

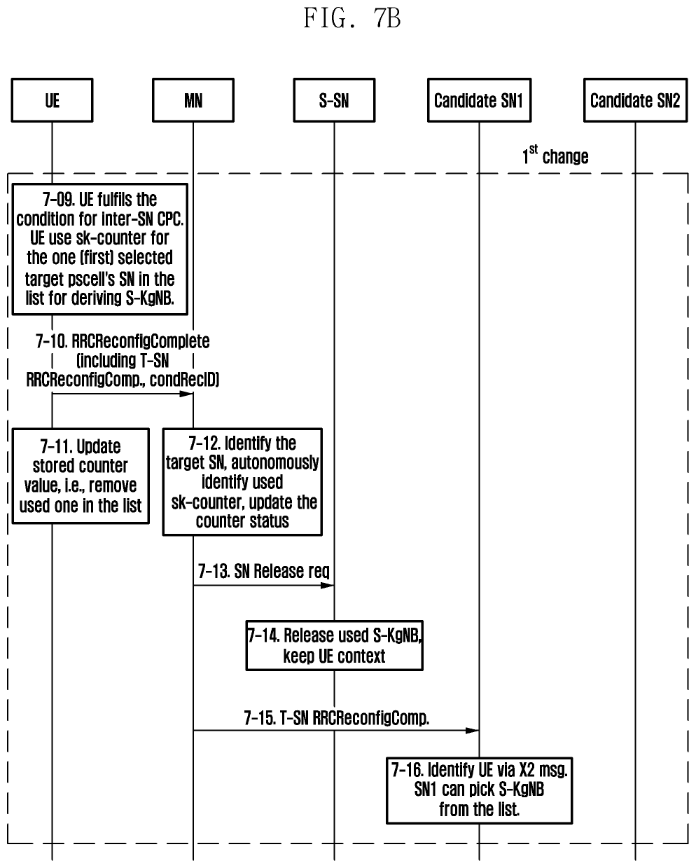

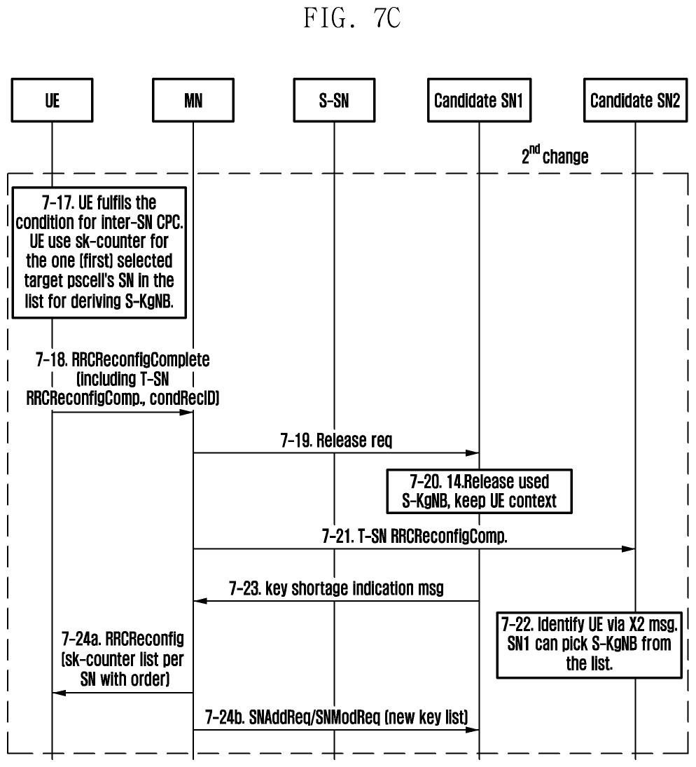

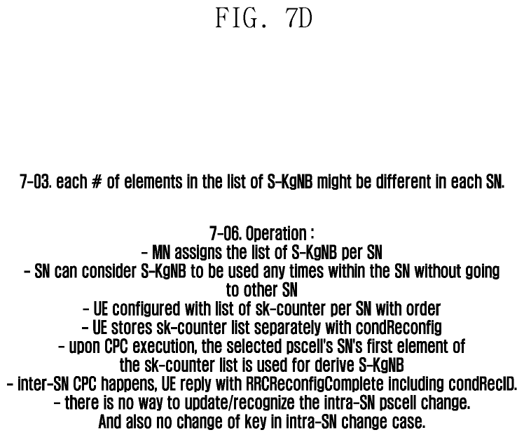

FIGS. 7A, 7B, 7C, and 7D illustrate an MN-initiated subsequent CPC procedure in OPT1 according to various embodiments of the disclosure.

Referring to FIGS. 7A, 7B, 7C, and 7D, in operation 7-01, the UE has been connected to the MN and source-SN (S-SN) in dual connection.

In operation 7-02, the MN may determine to configure the subsequent CPC. Therefore, the MN may determine a candidate SN based on the previous measurement results of the UE and determine a key list to be assigned to each candidate SN. In addition, the MN may determine the number of keys to be assigned to each SN.

In operations 7-03a, 7-03b, and 7-03c, the MN may request CPC configuration by transmitting a SNAddReq message to candidate SN(s), including the current S-SN. In addition, the MN may transmit a key list through the above message. The key list may include order information.

In addition, unlike the existing operation, the current S-SN must also be able to receive the SNAddReq message. In order to distinguish the above SNAddReq message from general SNAddReq messages, a separate indication or field (e.g., subsCPC) indicating that the message is for selective SCG activation or subsequent CPC configuration may be included in the message.

The message that the MN transmits to the S-SN may be a new message other than the SNAddReq message or a SNModRequest message. Even in this case, an indication indicating that the message is for subsequent CPC configuration may be included in the message.

In case where the MN includes the key previously assigned to the S-SN and used by the S-SN in the key list and transmits the same, the key that is currently used by the S-SN may be placed in the highest priority position in the key list received by the S-SN. Alternatively, in case where the MN transmits the key list without the key previously assigned to the S-SN and used by the S-SN, the S-SN may place the key currently in use at the first (or the highest priority) key position in the order of the received key list.

In operations 7-04a, 7-04b, or 7-04c, the SN that has received the message may store the key list (S-KgNB list) transmitted by the MN, based on the order. The SN may perform admission control to determine a candidate PSCell to which resources will be allocated.

The SN may determine configuration information, for example, the RRCReconfiguration message, to be used when the UE executes CPC for the determined candidate PSCell. In this case, a counter value may be separately included in the RRCReconfiguration message.

In case where the counter value is not included separately, the list of counter values transmitted by the MN to the UE may be used in the next operations.

If there is no admitted candidate cell, the SN does not store the key list.

In operations 7-05a, 7-05b, and 7-05c, each of the SNs may transmit a SNAddReqACK message to the MN, and the SNAddReqACK message may include the ID of the admitted candidate PSCell and CPC configuration information related to the PSCell ID.

In operation 7-06, the MN may maintain (or store) the admitted candidate PSCell information. In this case, the candidate PSCell information may include at least one of candidate PSCell ID and CPC configuration information. In addition, the MN may generate condition information for CPC execution for each candidate PSCell. In addition, the MN stores the key list assigned to the SN where the admitted cell exists.

In operation 7-071, the UE may be configured with at least one subCPC configuration by using the condition information for executing the CPC, CPC configuration information, and subsequent CPC configuration Id as one subCPC configuration. The MN may transmit subCPC configuration for each of the multiple candidate PSCells to the UE.

In this case, the MN may transmit, to the UE, a list of counter values corresponding to the key list transmitted to each SN in operation 7-03, through a separate field. The list may include order information.

In operation 7-072, the UE may transmit a response message to the RRCReconfiguration message to the MN.

In operation 7-08, the UE may store the received condition information for executing CPC, CPC configuration information, subsequent CPC configuration ID, and the counter list for each SN.

In operation 7-09, if the condition(s) for executing CPC on one of the candidate PSCells are fulfilled, the UE applies the configuration information of the corresponding cell. Then, the UE may derive the key value using the first value in the counter list of the SN to which the corresponding cell belongs.

After successfully executing the CPC, the UE may transmit an RRCReconfigurationComplete message to the MN in operation 7-10. The message may include an RRCReconfigurationComplete message for the target-SN (T-SN). In addition, the message may include a conditional Reconfiguration ID (condReconfigID) corresponding to the CPC executed by the UE. In addition, the message may include the counter value used by the UE and/or the derived key value corresponding to the counter value.

In operation 7-11, if the UE has executed the CPC to an SN different from the S-SN, the UE may discard, from the counter list assigned to the SN, the previously used counter value or the first ordered counter value (counter value with highest priority) in the current list.

The MN that has received the RRCReconfigurationComplete message may identify the target SN through condReconfigID in operation 7-12. In addition, the MN may identify the target PSCell.

In case where the S-SN to which the UE has been previously connected and the T-SN are different, the MN may discard the counter value previously used in the S-SN and the corresponding key value from the list corresponding to each SN. Through this, it is possible to maintain the same key list as the key list maintained by the UE.

Then, in operation 7-13, the MN may perform a release request by transmitting an SN Release request message to the S-SN.

The SN Release request message may include at least one of an indication of maintaining the UE context or a CPC SN change indication.

In addition, a new message indicating that the UE is leaving the cell of the corresponding SN, rather than the SN Release request message, may be used. For example, a new message called SN CPC indication message may be used, and the message may include at least one of the XnAP ID of the UE, the target SN ID executing CPC, and the selected target CPC PSCell ID information. In all of the following embodiments of the disclosure, the message may be used when the UE executes subsequent CPC and the MN notifies the source SN of this.

In operation 7-14, the S-SN recognizes that the corresponding UE is the UE that has executed subs CPC, and may release the key value that was used from the key list of subs CPC. The message or the indication in the message may imply that: Since subs CPC is executed as inter-SN and so the UE moves from the corresponding SN to another SN, the use of the security key per-SN is completed and if this UE performs the SN change to this SN again in the future, a new key has to be used.

In case where the message includes at least one of an indication of maintaining the UE context and a CPC SN change indication, the S-SN maintains the context of the corresponding UE.

In operation 7-15, the MN may transmit to the T-SN the RRCReconfigurationComplete message for the T-SN received in operation 7-10.

In operation 7-16, may receive the T-SN the RRCReconfigurationComplete message. The T-SN may identify the Transaction ID included in the corresponding message and identify that the UE that had executed subs CPC has moved from another one (S-SN). Therefore, the T-SN may communicate with the UE using the key with the highest priority among the key lists for the subs CPC for the corresponding UE.

In operation 7-17, if the condition(s) for executing CPC on one of the candidate PSCells are fulfilled, the UE applies the configuration information of the corresponding cell. Then, the UE may derive a key value using the first value in the counter list of the SN to which the corresponding cell belongs.

The operations 7-17 to 7-22 may be repeated similarly.

In operation 7-23, if a situation where all keys included in the list are released occurs in a specific SN during the above operations, the SN may transmit a message including an indication that all assigned keys have been exhausted to the MN. The MN that has received the message may transmit a SNAddReq message or SNModReq message including new key(s) to the MN in operation 7-24a. In this case, the MN may configure the key list information to the UE in operation 7-24b. In this case, the message for configuring the key list information to the UE may be an RRCReconfig message.

In the case of SN-initiated, the following operations may be considered.

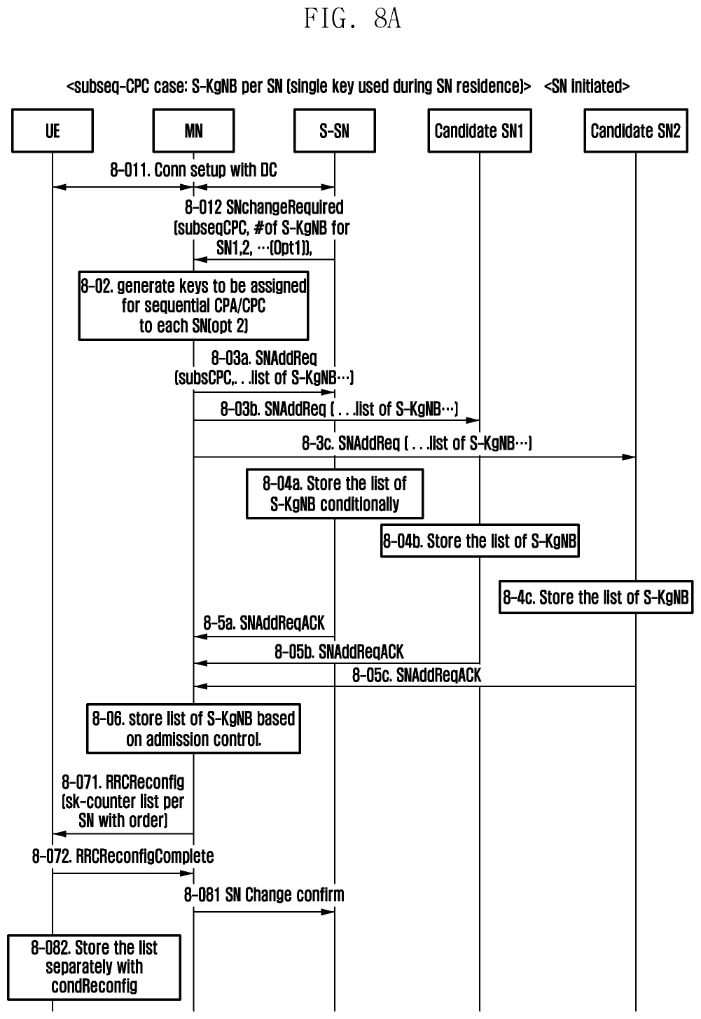

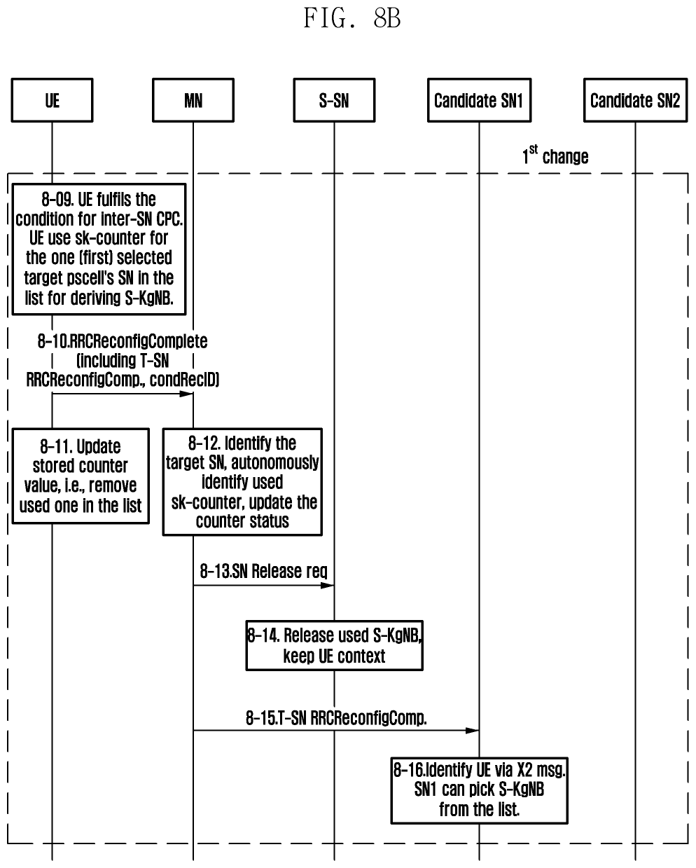

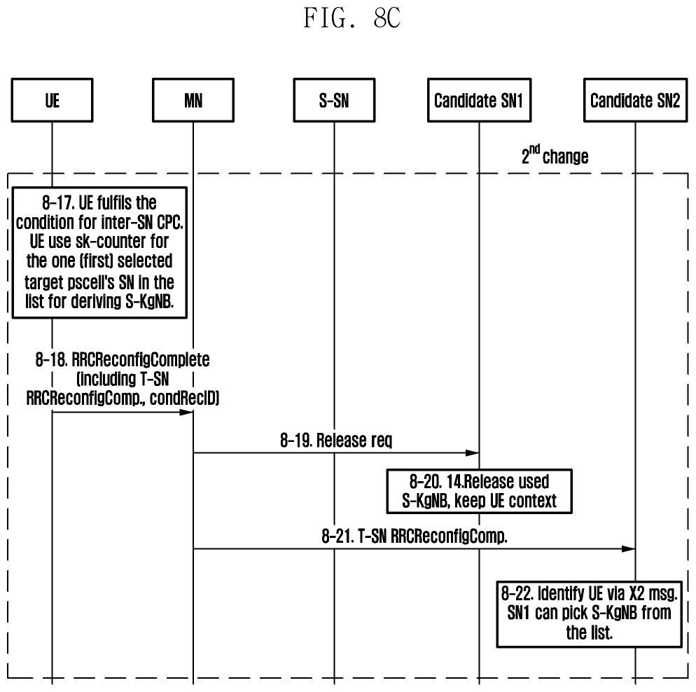

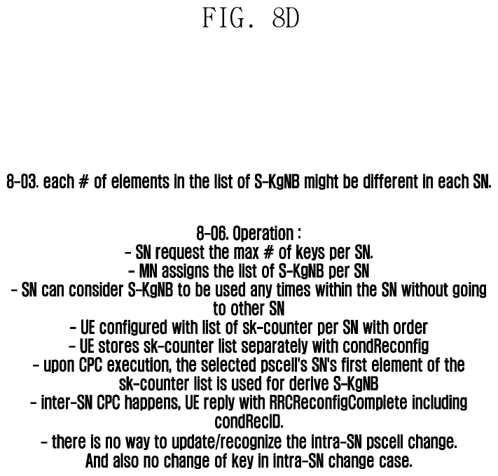

FIGS. 8A, 8B, 8C, and 8D illustrate an SN-initiated subsequent CPC procedure in OPT1 according to various embodiments of the disclosure.

Referring to FIGS. 8A, 8B, 8C, and 8D, in operation 8-011, the UE has been connected to the MN and S-SN in dual connection.

In operation 8-012, the S-SN may determine to perform subs CPC and transmit an SNchangeRequired message to the MN. The message may include measurement information on candidate PSCells included in each SN and the IDs of the cells. The T-SNs may determine the actual candidate PSCell only among the candidate PSCells.

The message may include an indication indicating the configuration of subsequent CPC.

The message may include information on the maximum number of keys that may be assigned to each SN. The MN may generate a key assigned to each SN within the maximum number of keys that may be assigned to each SN.

If the message does not include the maximum number information, the MN may determine and allocate the number of keys for each SN.

In operation 8-02, the MN is requested to configure subsequent CPC and may request subsequent CPC from the candidate target SN identified based on the message received from the SN. In addition, the key list to be assigned to the candidate target SN may be determined.

In operations 8-03a, 8-03b, and 8-03c, the MN may request CPC configuration by transmitting a SNAddReq message to candidate SN(s), including the current S-SN. In addition, the MN may transmit the key list through the above message. The key list may include order information.

In addition, unlike the existing operation, the current S-SN must also be able to receive the SNAddReq message. In order to distinguish the above SNAddReq message from general SNAddReq messages, a separate indication or field (e.g., subsCPC) indicating that the message is for selective SCG activation or subsequent CPC configuration may be included in the message.

The message that the MN transmits to the S-SN may be a new message other than the SNAddReq message or a SNModRequest message. Even in this case, an indication indicating that it is for subsequent CPC configuration may be included in the message.

In case where the MN includes the key previously assigned to the S-SN and used by the S-SN and transmits the same, the key that is currently used by the S-SN may be placed in the highest priority position in the key list received by the S-SN. Alternatively, in case where the MN transmits the key list without the key previously assigned to the S-SN and used by the S-SN, the S-SN may place the key currently in use at the first (or the highest priority) key in the order of the received key list.

In operations 8-04a, 8-04b, and 8-04c, the SN that has received the message may store the key list (S-KgNB list) transmitted by the MN, based on the order. The SN may perform admission control to determine a candidate PSCell to which resources will be allocated.

The SN may determine configuration information, for example, the RRCReconfiguration message, to be used when the UE executes CPC for the determined candidate PSCell. In this case, the counter value may be separately included in the RRCReconfiguration message.

In case where the counter value is not included separately, the list of counter values transmitted by the MN to the UE may be used in the next operations.

If there is no admitted candidate cell, the SN does not store the key list.

In operation 8-05a, 8-05b, and 8-05c, each of the SNs may transmit a SNAddReqACK message to the MN, and the SNAddReqACK message may include the ID of the admitted candidate PSCell and CPC configuration information related to the PSCell ID.

In operation 8-06, the MN may maintain (or store) the admitted candidate PSCell information. In this case, the candidate PSCell information may include at least one of candidate PSCell ID and CPC configuration information. In addition, the MN may generate condition information for CPC execution for each candidate PSCell. In addition, the MN stores the key list assigned to the SN where the admitted cell exists.

In operation 8-071, the UE may be configured with at least one subCPC configuration by using the condition information for executing the CPC, CPC configuration information, and subsequent CPC configuration ID as one subCPC configuration. The MN may transmit the subCPC configuration for each of the multiple candidate PSCells to the UE.

In this case, the MN may transmit, to the UE, a list of counter values corresponding to the key list transmitted to each SN in operation 8-03, through a separate field. The list may include order information.

In operation 8-072, the UE may transmit a response message to the RRCReconfiguration message to the MN.

In operation 8-082, the UE may store the received condition information for executing CPC, CPC configuration, subsequent CPC configuration ID, and the counter list for each SN.

In operation 8-081, the MN may notify the SN that the configuration for the UE is completed.

In operation 8-09, if the condition(s) for executing CPC on one of the candidate PSCells are fulfilled, the UE applies the configuration information of the corresponding cell. Then, the UE may derive the key value using the first value in the counter list of the SN to which the corresponding cell belongs.

After successfully executing the CPC, the UE may transmit an RRCReconfigurationComplete message to the MN in operation 8-10. The message may include an RRCReconfigurationComplete message for the T-SN. In addition, the message may include a conditional Reconfiguration ID (condReconfigID) corresponding to the CPC executed by the UE. In addition, the message may include the counter value used by the UE and/or the derived key value corresponding to the counter value.

In operation 8-11, if the UE has executed the CPC to an SN different from the S-SN, the UE may discard, from the counter list assigned to the SN, the previously used counter value or the first ordered counter value (a counter value with highest priority) in the current list.

The MN that has received the RRCReconfigurationComplete message may identify the target SN through condReconfigID in operation 8-12. In addition, the MN may identify the target PSCell.

In case where the S-SN to which the UE has been previously connected and the T-SN are different, the MN may discard the counter value previously used in the S-SN and the corresponding key value from the list corresponding to each SN. Through this, it is possible to maintain the same key list as the key list maintained by the UE.

Then, in operation 8-13, the MN may perform a release request by transmitting an SN Release request message to the S-SN.

The SN Release request message may include at least one of an indication of maintaining the UE context or a CPC SN change indication.

In operation 8-14, the S-SN recognizes that the corresponding UE is the UE that has executed subs CPC, and may release the key value it was using from the key list of subs CPC.

The message or the indication in the message may imply that: Since subs CPC is executed as inter-SN so the UE moves from the corresponding SN to another SN, the use of the security key per-SN is completed and if this UE performs the SN change this SN again in the future, a new key has to be used.

In case where the message includes at least one of an indication of maintaining the UE context or a CPC SN change indication, the S-SN maintains the context of the corresponding UE.

In operation 8-15, the MN may transmit to the T-SN the RRCReconfigurationComplete message for the T-SN received in operation 8-10.

In operation 8-16, T-SN the may receive the RRCReconfigurationComplete message. The T-SN may identify the Transaction ID included in the corresponding message and identify that the UE that has executed subs CPC has moved from another one (S-SN). Therefore, the T-SN may communicate with the UE using the key with the highest priority among the key list for subs CPC for the corresponding UE.

In operation 8-17, if the condition(s) for executing CPC on one of the candidate PSCells are fulfilled, the UE applies the configuration information of the corresponding cell. Then, the UE may derive the key value using the first value in the counter list of the SN to which the corresponding cell belongs. The operations 8-17 to 8-22 may be repeated similarly.

Hereinafter, OPT2 will be described.

OPT2: This refers to a case where multiple pairs of keys and associated counters are determined in advance and given to the UE with a CPC configuration. This is a case where the same key value is used in case of subsequent intra-SN CPCs by default, but a key change is requested in case of a specific PSCell.

In addition, CPC exists in both MN-initiated and SN-initiated cases. First, in the case of MN-initiated, the following procedures may be considered.

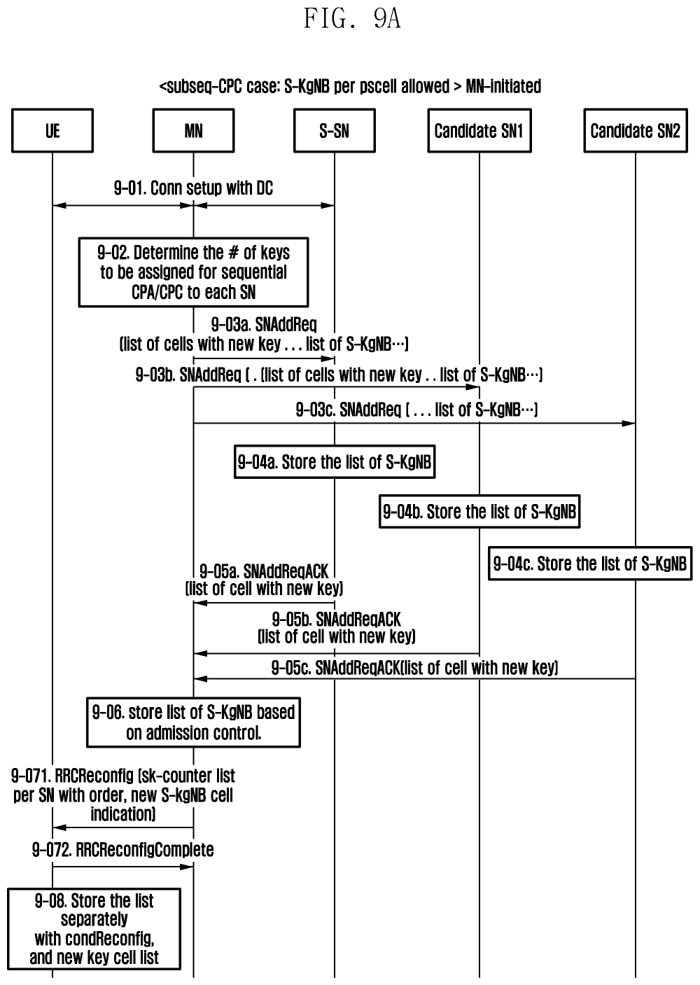

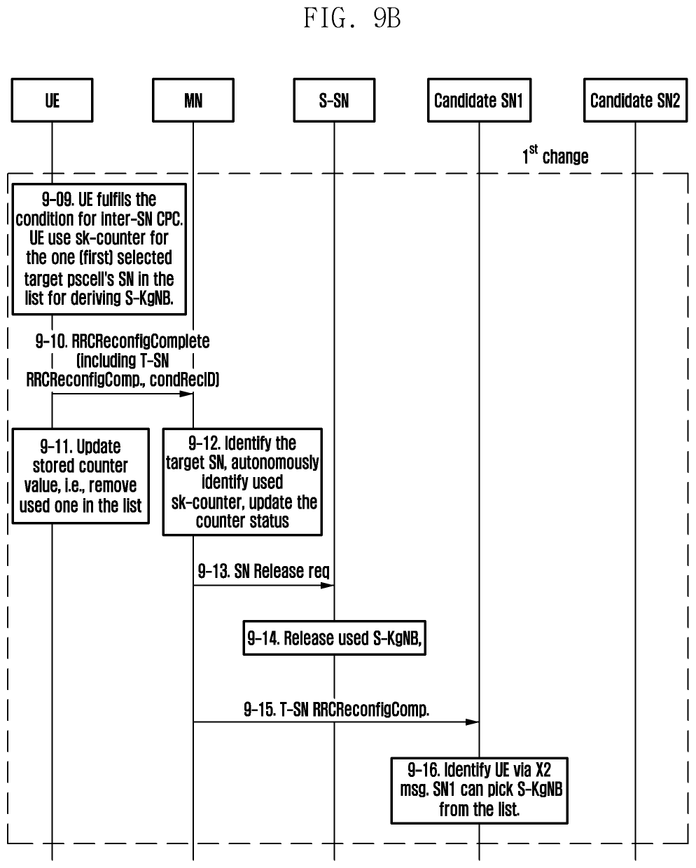

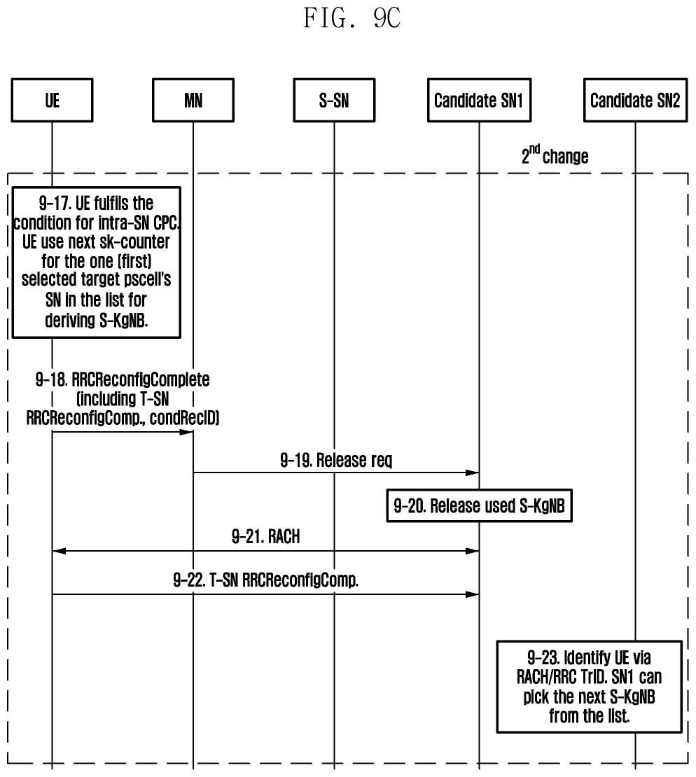

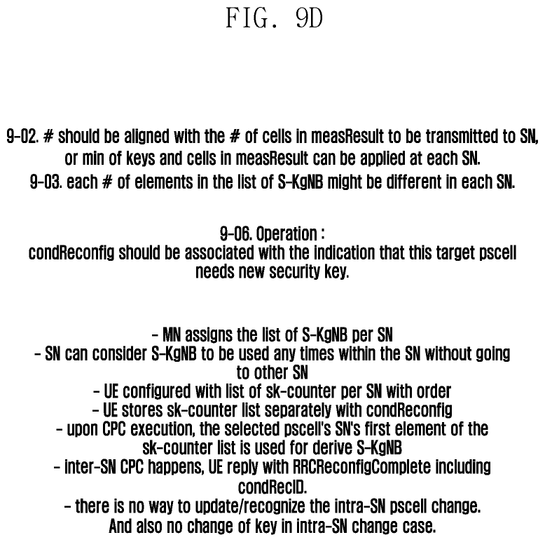

FIGS. 9A, 9B, 9C, and 9D illustrate an MN-initiated subsequent CPC procedure in OPT2 according to various embodiments of the disclosure.

Referring to FIGS. 9A, 9B, 9C, and 9D, in operation 9-01, the UE has been connected to the MN and S-SN in dual connection.

In operation 9-02, the MN may determine to configure the subsequent CPC. Therefore, the MN may determine a candidate SN based on the previous measurement results of the UE and determine a key list to be assigned to each candidate SN. In addition, the MN may determine the number of keys to be assigned to each SN.

In operations 9-03a, 9-03b, and 9-03c, the MN may request CPC configuration by transmitting a SNAddReq message to candidate SN(s), including the current S-SN. In addition, the MN may transmit a key list through the above message. The key list may include order information.

In addition, unlike the existing operation, the current S-SN must also be able to receive the SNAddReq message. In order to distinguish the SNAddReq message from general SNaddReq messages, a separate indication or field (e.g., subsCPC) indicating that the message is for selective SCG activation or subsequent CPC configuration may be included in the message.

The message that the MN transmits to S-Sn may be a new message other than the SNAddReq message or a SNModRequest message. Even in this case, an indication indicating that the message is for subsequent CPC configuration may be included in the message.

In case where the MN includes the key previously assigned to the S-SN and used by the S-SN in the key list and transmits the same, the key that is currently used by the S-SN may be placed in the highest priority position in the key list received by the S-SN. Alternatively, in case where the MN transmits the key list without the key previously assigned to the S-SN and used by the S-SN, the S-SN may place the key currently in use at the first (or the highest priority) key in the order of the received key list

For candidate PSCells of each SN, the MN may include information including the IDs of specific cells requiring a new key in the message.

In operations 9-04a, 9-04b, or 9-04c, the SN that has received the message may store the key list (S-KgNB list) transmitted by the MN, based on the order. The SN may perform admission control to determine a candidate PSCell to which resources will be allocated.

The SN may determine configuration information, for example, the RRCReconfiguration message, to be used when the UE executes CPC for the determined candidate PSCell. In this case, a counter value may be separately included in the RRCReconfiguration message.

In case where the counter value is not included separately, the list of counter values transmitted by the MN to the UE may be used in the next operations.

If there is no admitted candidate cell, the SN does not store the key list.

The SN may determine cells that require key refresh or security parameter refresh compared to the previous cells, among the finally admitted candidate cells.

In operations 9-05a, 9-05b, and 9-05c, each of the SNs may transmit a SNAddReqACK message to the MN, and the SNAddReqACK message may include the ID of the admitted candidate PSCell and CPC configuration information related to the PSCell ID.

In addition, the SN may transmit to the MN a separate ID and indication for the cells that require key refresh or security parameter refresh compared to the previous cells among the finally admitted candidate cells.

In operation 9-06, the MN may maintain (or store) the admitted candidate PSCell information. In this case, the candidate PSCell information may include at least one of candidate PSCell ID or CPC configuration information. In addition, the MN may generate condition information for CPC execution for each candidate PSCell. The MN stores the key list assigned to the SN where the admitted cell exists.

In operation 9-071, the UE may be configured with at least one subCPC configuration by using the condition information for executing the CPC, CPC configuration information, and subsequent CPC configuration ID as one subCPC configuration. The MN may transmit the subCPC configuration for each of multiple candidate PSCells to the UE.

In this case, the MN may transmit, to the UE, a list of counter values corresponding to the key list transmitted to each SN in operation 9-03, through a separate field. The list may include order information.

The MN may include a separate ID and indication for the cells that require key refresh or security parameter refresh compared to the previous cells, among the candidate cells finally admitted for each SN, and transmit the same to the UE.

In operation 9-072, the UE may transmit a response message to the RRCReconfiguration message to the MN.

In operation 9-08, the UE may store the received condition information for executing CPC, CPC configuration information, subsequent CPC configuration ID, and the counter list for each SN. In addition, the UE may store the ID of the cell requiring key refresh.

In operation 9-09, if the condition(s) for executing CPC on one of the candidate PSCells are fulfilled, the UE applies the configuration information of the corresponding cell. Then, the UE may derive the key value using the first value in the counter list of the SN to which the cell belongs.

In case where the cell is another cell in the current SN and with key refresh indicated, the UE may discard the first priority counter value from the counter list for the SN and derive the key value using the next priority counter value. An embodiment of the disclosure is a situation in which another SN cell is selected.

After successfully executing the CPC, the UE may transmit an RRCReconfigurationComplete message to the MN in operation 9-10. The message may include an RRCReconfigurationComplete message for the T-SN. In addition, the message may include a conditional Reconfiguration ID (condReconfigID) corresponding to the CPC executed by the UE. In addition, the message may include the counter value used by the UE and/or the derived key value corresponding to the counter value.

In operation 9-11, if the UE has executed the CPC to an SN different from the S-SN, the UE may discard, from the counter list allocated to the S-SN, the previously used counter value or the first ordered counter value (a counter value with highest priority) in the current list.

The MN that has received the RRCReconfigurationComplete message may identify the target SN through condReconfigID in operation 9-12. In addition, the MN may identify the target PSCell.

In case where the S-SN to which the UE has been previously connected and the T-SN are different, that is, in the case of inter-SN CPC, the MN may discard the counter value previously used in the S-SN and the corresponding key value from the list corresponding to each SN. Through this, it is possible to maintain the same key list as the key list maintained by the UE.

Then, in operation 9-13, the MN may perform a release request by transmitting an SN Release request message to the S-SN.

The SN Release request message may include at least one of an indication of maintaining the UE context or a CPC SN change indication.

In operation 9-14, the S-SN recognizes that the corresponding UE is a UE that has executed subs CPC, and may release the key value that was used from the key list of subs CPC.

The message or the indication in the message may imply that: Since subs CPC is executed as inter-SN so the UE moves from the corresponding SN to another SN, the use of the security key per-SN is completed and if this UE performs the SN change to this SN again in the future, a new key has to be used.

In case where the message includes at least one of an indication of maintaining the UE context or a CPC SN change indication, the S-SN maintains the context of the corresponding UE.

The key used by the SN for the UE may be released.

In operation 9-15, the MN may transmit to the T-SN the RRCReconfigurationComplete message for the T-SN received in operation 9-10.

In operation 9-16, the T-SN may receive the SN Reconfiguration Complete message, which is an Xn message, and the RRCReconfigComplete message included in the message. The T-SN may identify the Transaction ID included in the message and identify that the UE that has executed subs CPC has moved from another one (S-SN). Therefore, the T-SN may communicate with the UE using the key with the highest priority among the key list for subs CPC for the corresponding UE.

In operation 9-17, if the condition(s) for executing CPC on one of the candidate PSCells are fulfilled, the UE applies the configuration information of the corresponding cell. Then, the UE may derive the key value using the first value in the counter list of the SN to which the corresponding cell belongs.

In case where a cell requiring a new key is selected during intra-SN CPC, in case where the cell is another cell in the current SN and with key refresh indicated, the UE may discard the first ordered counter value from the counter list for the SN, and then derive the key value using the next ordered counter value.

In this case, the UE must complete CPC by performing RACH to a target cell. The configuration information of the target cell received from the SN in operation 9-05a, 9-05b, or 9-05c may include at least one of information, such as configuration information for performing the RACH, an indication indicating key refresh, and PDCP change indication.

In case of performing RACH when executing subs CPC to a target cell, the UE may use RACH resource information configured for subs CPC. The target node may identify the used RACH resource information and the transaction ID of the RRCReconfigurationComplete message, and may identify that the UE has executed subs CPC in intra-SN. When the target node identifies that the UE has executed intra-SN CPC, the target node knows that the corresponding cell is a new key cell, and thereafter, discards the first ordered value from the key list and communicates with the UE using the next ordered key value.

The operations 9-17 to 9-23 may be repeated similarly.

If a situation where all keys included in the list are released occurs in a specific SN during the above operations, the SN may transmit a message including an indication that all assigned keys have been exhausted to the MN. The MN that has received the message may transmit a SNAddReq message or SNModReq message including new key(s) to the MN. In this case, the MN may configure the key list information to the UE. In this case, the message for configuring the key list information to the UE may be an RRCReconfig message.

In case of SN-initiated, the following procedures may be considered.

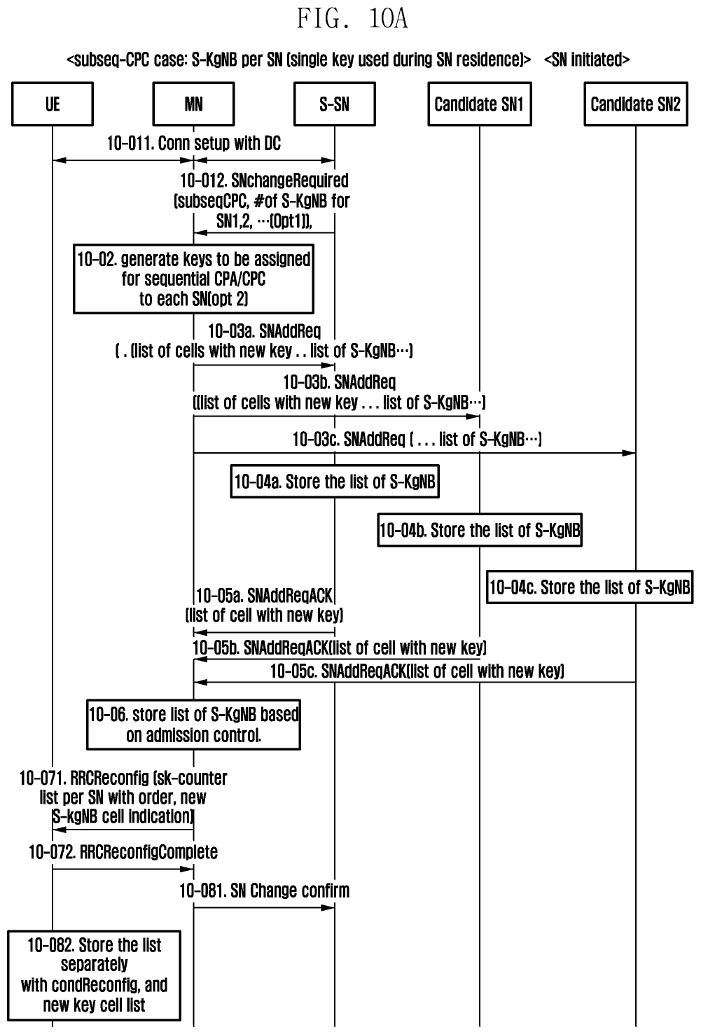

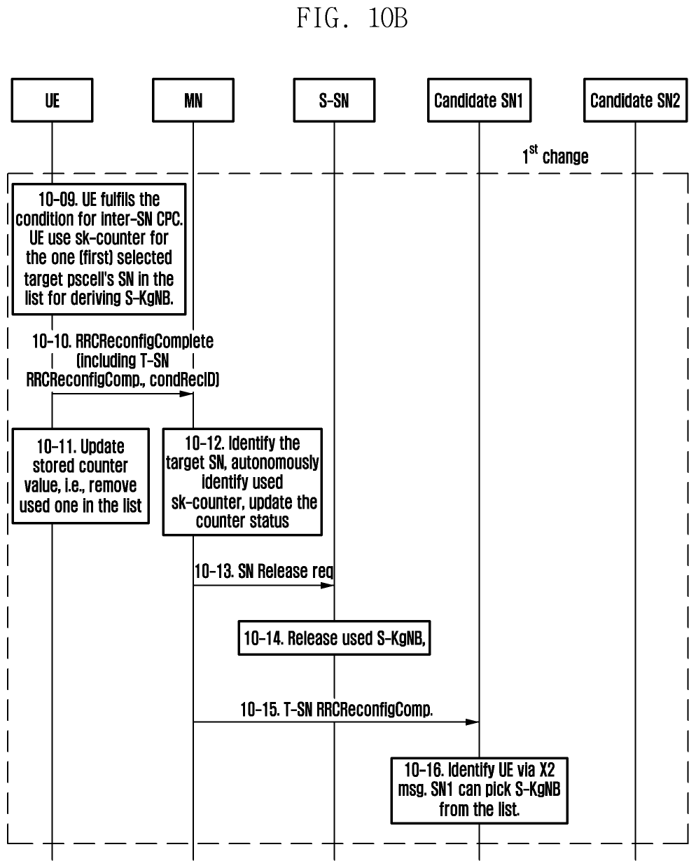

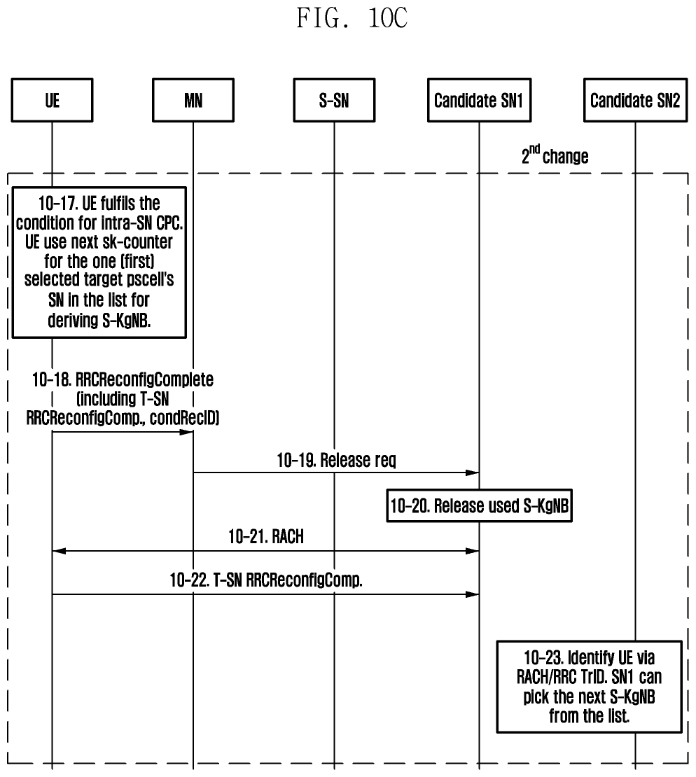

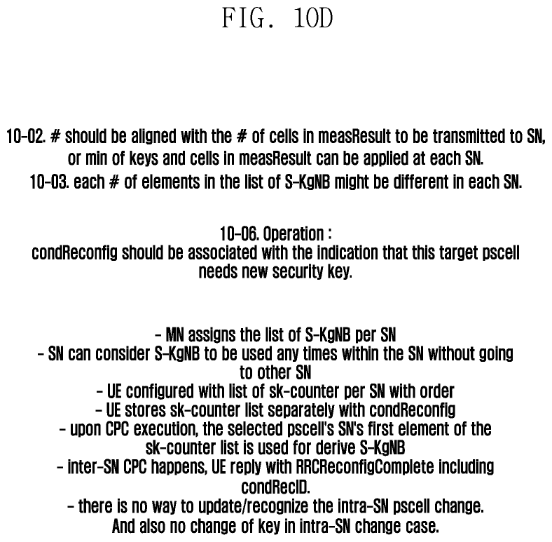

FIGS. 10A, 10B, 10C, and 10D illustrate an SN-initiated subsequent CPC procedure in OPT2 according to various embodiments of the disclosure.

Referring to FIGS. 10A, 10B, 10C, and 10D, in operation 10-011, the UE has been connected to the MN and S-SN in dual connection.

In operation 10-012, the S-SN may determine to perform subs CPC and transmit an SNchangeRequired message to the MN. The message may include measurement information on candidate PSCells included in each SN and the IDs of the cells. T-SNs may determine the actual candidate PSCell only among the candidate PSCells.

The message may include an indication indicating the configuration of subsequent CPC.

The message may include information on the maximum number of keys that may be assigned to each SN. The MN may generate keys to be assigned to each SN within the maximum number of keys that may be assigned to each SN.

If the message does not include the maximum number information, the MN may determine and allocate the number of keys for each SN.

In operation 10-02, the MN is requested to configure subsequent CPC and may request subsequent CPC from the candidate target SN identified based on the message received from the SN. In addition, the key list to be assigned to the corresponding candidate target SN may be determined.

In operations 10-03a, 10-03b, and 10-03c, the MN may request CPC configuration by transmitting a SNAddReq message to candidate SN(s), including the current S-SN. In addition, the MN may transmit the key list through the above message. The key list may include order information.

In addition, unlike the existing operation, the current S-SN must also be able to receive the SNAddReq message. In order to distinguish the SNAddReq message from general SNaddReq messages, a separate indication or field (e.g., subsCPC) indicating that the message is for selective SCG activation or subsequent CPC configuration may be included in the message.

The message that the MN transmits to the S-SN may be a new message other than the SNAddReq message or a SNModRequest message. Even in this case, an indication indicating that it is for subsequent CPC configuration may be included in the message.

In case where the MN includes the key previously assigned to the S-SN and used by the S-SN and transmits the same, the key that is currently used by the S-SN may be placed in the highest priority position in the key list received by the S-SN. Alternatively, in case where the MN transmits the key list without the key previously assigned to the S-SN and used by the S-SN, the S-SN may place the key currently in use at the first (or the highest priority) key in the order of the received key list.

The information including the ID of the candidate PSCell that requires a new key for each SN may be included in the message.

In operations 10-04a, 10-04b, and 10-04c, the SN that has received the message may store the key list (S-KgNB list) transmitted by the MN based on the order. The SN may perform admission control to determine a candidate PSCell to which resources will be allocated.

The SN may determine configuration information, for example, the RRCReconfiguration message, to be used when the UE executes CPC for the determined candidate PSCell. In this case, a counter value may be separately included in the RRCReconfiguration message.

In case where the counter value is not included separately, the list of counter values transmitted by the MN to the UE may be used in the next operations.

If there is no admitted candidate cell, the SN does not store the key list.

The SN may determine cells that require key refresh or security parameter refresh compared to previous cells, among the finally admitted candidate cells.

In operations 10-05a, 10-05b, and 10-05c, each of the SNs may transmit a SNAddReqACK message to the MN, and the SNAddReqACK message may include the ID of the admitted (allowed) candidate PSCell and CPC configuration information related to the PSCell ID.

In addition, the SN may transmit to the MN a separate ID and indication for the cells that require key refresh or security parameter refresh compared to the previous cells, among the finally admitted candidate cells.

In operation 10-06, the MN may maintain (or store) the admitted candidate PSCell information. In this case, the candidate PSCell information may include at least one of candidate PSCell ID or CPC configuration information. In addition, the MN may generate condition information for CPC execution for each candidate PSCell. In addition, the MN stores the key list assigned to the SN where the admitted cell exists.

In operation 10-071, the UE may be configured with at least one subCPC configuration by using the condition information for executing the CPC, CPC configuration information, and subsequent CPC configuration ID as one subCPC configuration. The MN may transmit subCPC configuration for each of multiple candidate PSCells to the UE.

In this case, the MN may transmit, to the UE, a list of counter values corresponding to the key list transmitted to each SN in operation 10-03, through a separate field. The list may include order information.

The MN may include a separate ID and indication for cells that require key refresh or security parameter refresh compared to the previous cells among the finally admitted candidate cells for each SN, and transmits the same to the UE.

In operation 10-072, the UE may transmit a response message to the RRCReconfiguration message to the MN.

In operation 10-082, the UE may store the received condition information for executing CPC, CPC configuration information, subsequent CPC configuration ID, and the counter list for each SN. In addition, the UE may store the ID of the cell requiring key refresh.

In operation 10-081, the MN may notify the SN that the configuration for the UE is completed.

In operation 10-09, if the condition(s) for executing CPC on one of the candidate PSCells are fulfilled, the UE applies the configuration information of the corresponding cell. Then, in this case, the key value may be derived using the first value in the counter list of the SN to which the corresponding cell belongs.

After successfully executing the CPC, the UE may transmit an RRCReconfigurationComplete message to the MN in operation 10-10. The message may include an RRCReconfigurationComplete message for the T-SN. In addition, the message may include a conditional Reconfiguration ID (condReconfigID) corresponding to the CPC executed by the UE. In addition, the message may include the counter value used by the UE and/or the derived key value corresponding to the counter value.

In operation 10-11, if the UE has executed the CPC to an SN different from the S-SN, the UE may discard, from the counter list allocated to the S-SN, the previously used counter value or the first ordered counter value (a counter value with highest priority) in the current list.

The MN that has received the RRCReconfigurationComplete message may identify the target SN through condReconfigID in operation 10-12. In addition, the MN may identify the target PSCell.

In case where the S-SN to which the UE was previously connected and the T-SN are different, that is, in the case of inter-SN CPC, the MN may discard the counter value previously used in the S-SN and the corresponding key value from the list corresponding to each SN. Through this, it is possible to maintain the same key list as the key list maintained by the UE.

Then, in operation 10-13, the MN may perform a release request by transmitting an SN Release request message to the S-SN.

The SN Release request message may include at least one of an indication of maintaining the UE context or a CPC SN change indication.

In operation 10-14, the S-SN recognizes that the corresponding UE is a UE that has executed subs CPC, and may release the key value that was used from the key list of subs CPC.

The message or the indication in the message may imply that: Since subs CPC is executed as inter-SN so the UE moves from the corresponding SN to another SN, the use of the security key per-SN is completed, and if this UE performs the SN change to this SN again in the future, a new key has to be used.

In case where the message includes at least one of an indication of maintaining the UE context or a CPC SN change indication, the S-SN maintains the context of the corresponding UE.

The key used by the SN for the UE may be released.

In operation 10-15, the MN may transmit to the T-SN the RRCReconfigurationComplete message for the T-SN received in operation 10-10.

In operation 10-16, the T-SN may receive the SN Reconfiguration Complete message, which is an Xn message, and the RRCReconfigComplete message included in the message. The T-SN may identify the Transaction ID included in the corresponding message and identify that the UE that has executed subs CPC has moved from another one (S-SN). Therefore, the T-SN may communicate with the UE using the key with the highest priority among the key list for subs CPC for the corresponding terminal.

In operation 10-17, if the condition(s) for executing CPC on one of the candidate PSCells are fulfilled, the UE applies the configuration information of the corresponding cell. Then, the UE may derive the key value using the first value in the counter list of the SN to which the corresponding cell belongs.

In case where a cell requiring a new key is selected during intra-SN CPC, in case where the cell is another cell in the current SN and with key refresh indicated, the UE may discard the first ordered counter value from the counter list for the SN, and then derive the key value using the next ordered counter value.

In this case, the UE must complete CPC by performing RACH to a target cell. The configuration information of the target cell received from the SN in operation 10-05a, 10-05b, or 10-05c may include at least one of information, such as configuration information for performing the RACH, an indication indicating key refresh, and PDCP change indication.

In case of performing RACH when executing subs CPC to a target cell, the UE may use RACH resource information configured for subs CPC. The target node identifies the used RACH resource information and the transaction ID of the RRCReconfigurationComplete message, and may know that the UE has executed subs CPC in intra-SN. When the target node identifies that the UE has executed intra-SN CPC, the target node knows that the corresponding cell is a new key cell, so thereafter, it discards the first ordered value from the key list and communicates with the UE using the next ordered key value.

The operations 10-17 to 10-23 may be repeated similarly.

If a situation where all keys included in the list are released occurs in a specific SN during the above operations, the SN may transmit a message including an indication that all assigned keys have been exhausted to the MN. The MN that has received the message may transmit a SNAddReq message or SNModReq message including new key(s) to the MN. In this case, the MN may configure the key list information to the UE. In this case, the message for configuring the key list information to the UE may be an RRCReconfig message.

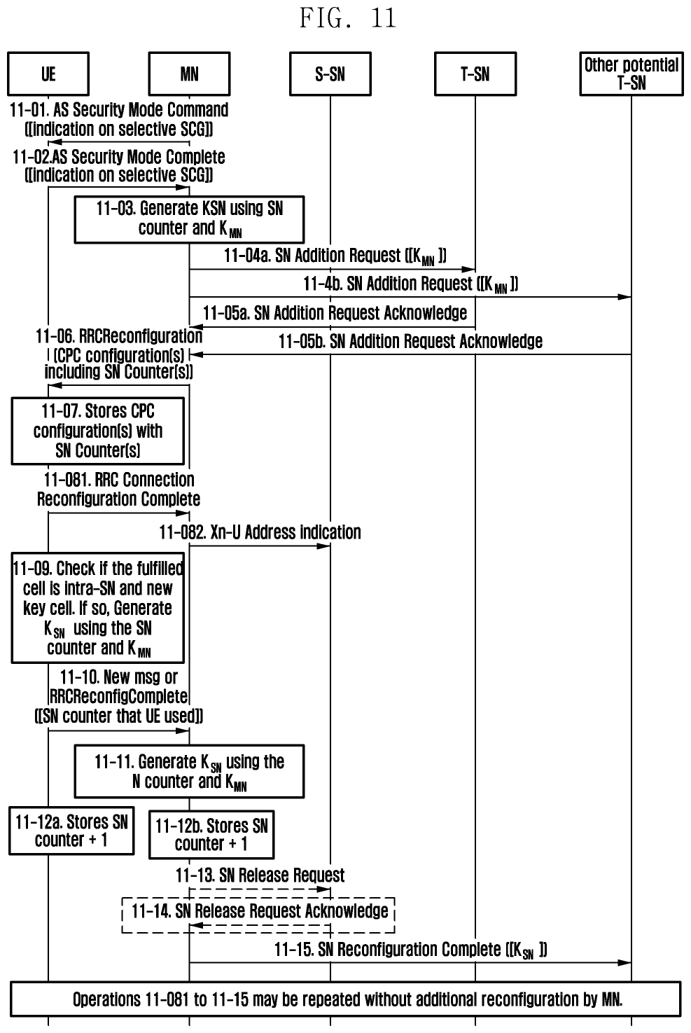

FIG. 11 illustrates a process for generating a K_{SN} in a UE and MN in a conditional subsequent SN change in a dual connectivity situation according to an embodiment of the disclosure.

Referring to FIG. 11, in operation 11-01, the MN may include an indication indicating whether selective SCG is supported in an AS Security Mode Command message and transmit the same to the UE. If this indication is not transmitted, it may imply that the MN does not support selective SCG.

The AS Security Mode Command message may be the first integrity-protected message among AS messages. Selective SCG may mean a process that subsequently enables the process in which when the MN requests resource allocation for a PDU Session or QoS Flow for the corresponding UE from several SNs, and if the MN transmits an RRC Reconfiguration message including SN RRC configuration conditional information for each SN, in case where a specific situation is met, the UE changes to the SN that matches the situation using the received conditional information. For example, selective SCG may mean that: In case where the MN transmits an indication that it supports selective SCG, the UE that has received SN RRC configuration conditional information for multiple SNs may request the MN to change the SN whenever the condition is met without additional configuration information received from the MN.

In operation 11-02, the UE may include an indication indicating whether selective SCG is supported in an AS Security Mode Complete message and transmit the same the MN. If this indication is not transmitted, it may imply that the UE does not support selective SCG. The AS Security Mode Complete message may be the first AS message to be encrypted and integrity protected, among the AS messages.

In operation 11-03, in some cases, the MN may generate a K_{SN} using the SN counter and K_{MN}. The K_{SN} is a key used by a secondary node (SN). Using the K_{SN}, a key used for encryption and integrity protection of user plane (UP) data exchanged between the UE and the SN may be generated. To generate the K_{SN}, the MN may use at least one of K_{MN}, 0x79, SN Counter value, and SN Counter length as an input value.

The cases where the MN is able to determine not to generate the K_{SN} in the corresponding operation may include, for example, a case where the MN knows that the UE supports selective SCG, or a case where the MN knows that it needs to request resource allocation from multiple SNs to enable the UE to perform conditional SN changes.

The MN may additionally indicate the IDs of cells requiring new keys among candidate PSCells and transmit the indicated IDs to each SN.

In operations 11-04a and 11-04b, the MN may request resource allocation for one or more PDU Sessions or QoS Flows to the SN(s) using the SN Addition Request message. The SN Addition Request message may include at least one of K_{SN}, UP security capabilities (a list of encryption algorithms and a list of integrity protection algorithms supported by the UE), and UP security policy (which is a factor indicating whether UP data encryption and integrity protection will be performed, and may have one of the values “Required”, “Preferred”, and “Not Needed” for encryption and integrity protection).

If the MN did not generate the K_{SN} in operation 11-03, the MN may not transmit the K_{SN} in the corresponding operation. In order to enable the UE to perform conditional subsequent SN change, the process in which the MN requests resource allocation to the SN through the SN Addition Request message may be requested not to one SN but to multiple SNs.

In operations 11-05a and 11-05b, if the SN(s) may accept the request for resource allocation by the MN in operation 11-04a or 11-04b, the SN(s) may transmit an SN Addition Request Acknowledge in response to operation 11-04 or 11-04b. The SN Addition Request Acknowledge message may include at least one of indications of the algorithm selected by the SN, whether UP data integrity is protected, and whether UP data is encrypted. In addition, the SN Addition Request Acknowledge message may include an SN RRC configuration message including radio resource configuration.

In addition, the SN may admit cells that need a new key transmitted by the MN, or reply to the MN with a separate indication for cells that need a new key, among candidate PSCells admitted by the SN itself.

In operation 11-06, the MN may transmit to the UE an RRC Connection Reconfiguration message that may include the SN RRC configuration(s) message received from the SN(s) in operation 11-05a or 11-05b. The RRC Connection Reconfiguration message may include conditional PSCell change (CPC) configuration information (list of RRC Connection Reconfiguration messages transmitted by each SN). In addition, the RRC Connection Reconfiguration message may include at least one of the SN Counter managed by the MN, the algorithm selected by the SN, and an indication of UP data encryption and integrity protection. In the corresponding operation, the MN may not transmit the SN counter value, the MN may transmit an SN counter applied to each of the SNs (i.e., includes an SN counter for each SN RRC configuration), or the MN may transmit only one SN counter. The case where the MN does not transmit an SN counter value or transmits only one SN counter value may include, for example, a case where the MN knows that the UE supports selective SCG through operation 11-02. The case where the MN transmits an SN counter applied to each of the SNs may include, for example, a case where the MN has known that the UE does not support selective SCG or a case where the MN does not support selective SCG.

In operation 11-07, if the MN has transmitted the CPC configuration information and SN Counter value(s) in operation 11-06, the UE may store the value(s).

In operation 11-081, the UE may apply the RRCReconfiguration message transmitted by the MN and store the CPC configuration information transmitted by the MN in operation 11-06. In operation 11-082, the MN may inform the source SN that CPC information has been configured to the UE through an Xn-U Address Indication process.

In operation 11-09, the UE performs execution condition evaluation based on the CPC configuration information received from the MN in operation 11-06, and the results of evaluation may be satisfied in this operation. If the execution condition(s) for one candidate SN are fulfilled, the UE may prepare to connect to the SN. The UE may determine whether the cell that satisfies the CPC condition is an intra-SN cell and whether it is a cell that requires a new key. In case where the cell is an intra-SN cell, separate key generation may not be necessary. However, in case the cell is an intra-SN cell and a cell that requires a new key, operations related to the new key generation may be necessary as shown below.

If the UE has stored the SN Counter value received from the MN in operation 11-07, the K_{SN} may be generated using at least one of the SN Counter value, K_{MN}, 0x79, and the length of the SN Counter as input. If the UE did not store the SN Counter because the MN did not transmit the SN Counter value(s) in operation 11-06, the K_{SN} may be generated using the SN Counter value separately stored by the UE.

In operation 11-10, the UE may evaluate execution conditions based on the CPC configuration information received from the MN in operation 11-06 and then transmit an RRC connection reconfiguration complete message notifying the MN of the selected SN. This message may also include the SN Counter value used by the UE in generating the K_{SN}. In case where the selected cell is an intra-SN cell, a new message may be used instead of the RRC (Connection) reconfiguration complete message. For example, an RRC message, such as ULInformationMRDC may be used. This new message may include an indication for completion of selective SCG (or subs CPC) execution and whether it is intra-SN CPC and/or performed with a new key cell.

In operation 11-11, if the MN did not generate the K_{SN} in operation 11-03, the K_{SN} may be generated using the SN Counter value transmitted by the UE in operation 11-10, by using K_{MN}, 0x79, the length of the SN Counter, or the like, as input. Alternatively, even if the UE did not transmit the SN Counter value in operation 11-10, the SN Counter value stored by the MN may be used.

In operation 11-12b, if the MN has generated the K_{SN} in operation 11-11, the MN may store the SN Counter value used in operation 11-11 by adding 1. in operation 11-12a, if the UE has transmitted the SN Counter value used by the UE to generate the K_{SN} in the RRC Connection Reconfiguration Complete message in operation 11-10, the UE may add 1 to the SN Counter value and store the value after transmitting the RRC Connection Reconfiguration message.

In operation 11-13, the MN may transmit an SN Release Request message to a source SN (S-SN).

In operation 11-14, the S-SN may transmit an SN Release Request Acknowledge message to the MN.

The operations 11-13 and 11-14 may not be performed in case where the intra-SN CPC is performed in operation 11-09.

In operation 11-15, if the MN has generated the K_{SN} in operation 11-11 rather than in operation 11-03, the K_{SN} may be included in the SN Reconfiguration Complete message and transmitted to the SN.

The operations 11-081 through 11-15 may occur continuously without additional operations 11-01 through 11-07.

The methods according to embodiments described in the claims or the specification of the disclosure may be implemented by hardware, software, or a combination of hardware and software.

In case where the methods are implemented by software, a computer-readable storage medium for storing one or more programs (software modules) may be provided. The one or more programs stored in the computer-readable storage medium may be configured for execution by one or more processors within an electronic device. The at least one program may include instructions that cause the electronic device to perform the methods according to embodiments of the disclosure as defined by the claims and/or disclosed herein.

The programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in memory formed by any combination of some or all of them. Further, a plurality of such memories may be included.

In addition, the programs may be stored in an attachable storage device which may access through communication networks, such as the Internet, Intranet, LAN, wide LAN (WLAN), and storage area network (SAN) or a combination thereof. Such a storage device may access an apparatus performing the embodiments of the disclosure via an external port. Further, a separate storage device on the communication network may access the apparatus performing the embodiments of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, information on a subsequent conditional primary secondary cell group (SCG) cell (PSCell) change configuration and information on a list of sk-counter values;
identifying that a condition associated with a subsequent conditional PSCell change execution for a target cell is fulfilled based on the subsequent conditional PSCell change configuration;
determining a firstly listed entry in the list of sk-counter values as an sk-counter value for a security key update; and
applying configuration information for the target cell.

2. The method of claim 1, further comprising removing the sk-counter value from the list of sk-counter values.

3. The method of claim 1, further comprising transmitting, to the base station, a first radio resource control (RRC) reconfiguration complete message including a second RRC reconfiguration complete message for the target cell, a conditional reconfiguration identifier (ID) for the target cell, and the sk-counter value.

4. The method of claim 1, wherein the list of sk-counter values is configured per secondary node (SN).

5. The method of claim 4, wherein the security key update is not performed for an intra-SN subsequent conditional PSCell change.

6. A method performed by a base station in a wireless communication system, the method comprising:
transmitting, to each of at least one secondary node (SN), an SN addition request message indicating that a subsequent conditional primary secondary cell group (SCG) cell (PSCell) change is requested;
in response to the SN addition request message, receiving, from each of the at least one SN, an SN addition request acknowledgement message including configuration information for the subsequent conditional PSCell change; and
based on the configuration information, transmitting, to a terminal, information on a subsequent conditional PSCell change configuration and information on a list of sk-counter values, wherein a firstly listed entry in the list of sk-counter values is determined as an sk-counter value for a security key update.

7. The method of claim 6, further comprising receiving, from the terminal, a first radio resource control (RRC) reconfiguration complete message including a second RRC reconfiguration complete message for a target cell of a subsequent conditional PSCell change execution, a conditional reconfiguration identifier (ID) for the target cell, and the sk-counter value.

8. The method of claim 7, further comprising:
identifying a target SN of the target cell based on the conditional reconfiguration ID; and
transmitting, to the target SN, the second RRC reconfiguration complete message.

9. The method of claim 6, wherein the list of sk-counter values is configured per secondary node (SN).

10. The method of claim 6, further comprising transmitting, to a last serving SN, a message informing a completion of the subsequent conditional PSCell change.

11. A terminal in a wireless communication system, the terminal comprising:
a transceiver; and
a controller configured to:
receive, from a base station via the transceiver, information on a subsequent conditional primary secondary cell group (SCG) cell (PSCell) change configuration and information on a list of sk-counter values,
identify that a condition associated with a subsequent conditional PSCell change execution for a target cell is fulfilled based on the subsequent conditional PSCell change configuration,
determine a firstly listed entry in the list of sk-counter values as an sk-counter value for a security key update, and
apply configuration information for the target cell.

12. The terminal of claim 11, wherein the controller is further configured to remove the sk-counter value from the list of sk-counter values.

13. The terminal of claim 11, wherein the controller is further configured to transmit, to the base station via the transceiver, a first radio resource control (RRC) reconfiguration complete message including a second RRC reconfiguration complete message for the target cell, a conditional reconfiguration identifier (ID) for the target cell, and the sk-counter value.

14. The terminal of claim 11, wherein the list of sk-counter values is configured per secondary node (SN).

15. The terminal of claim 14, wherein the security key update is not performed for an intra-SN subsequent conditional PSCell change.

16. A base station in a wireless communication system, the base station comprising:
a transceiver; and
a controller configured to:
transmit, to each of at least one secondary node (SN) via the transceiver, an SN addition request message indicating that a subsequent conditional primary secondary cell group (SCG) cell (PSCell) change is requested,
in response to the SN addition request message, receive, from each of the at least one SN via the transceiver, an SN addition request acknowledgement message including configuration information for the subsequent conditional PSCell change, and
based on the configuration information, transmit, to a terminal via the transceiver, information on a subsequent conditional PSCell change configuration and information on a list of sk-counter values, wherein a firstly listed entry in the list of sk-counter values is determined as an sk-counter value for a security key update.

17. The base station of claim 16, wherein the controller is further configured to receive, from the terminal via the transceiver, a first radio resource control (RRC) reconfiguration complete message including a second RRC reconfiguration complete message for a target cell of a subsequent conditional PSCell change execution, a conditional reconfiguration identifier (ID) for the target cell, and the sk-counter value.

18. The base station of claim 17, wherein the controller is further configured to:
identify a target SN of the target cell based on the conditional reconfiguration ID, and
transmit, to the target SN via the transceiver, the second RRC reconfiguration complete message.

19. The base station of claim 16, wherein the list of sk-counter values is configured per secondary node (SN).

20. The base station of claim 16, wherein the controller is further configured to transmit, to a last serving SN via the transceiver, a message informing a completion of the subsequent conditional PSCell change.
